(19) United States
(12) Patent Application Publication
(10) Pub. No.: US 2010/0257966 A1
(43) Pub. Date: Oct. 14, 2010

(54) DOUBLE CLUTCH TRANSMISSION

(75) Inventors: Wolfgang RIEGER, Friedrichshafen (DE); Philip RECKER, Friedrichshafen (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,998

(22) Filed: Apr. 13, 2010

(30) Foreign Application Priority Data
Apr. 14, 2009 (DE) 10 2009 002 357.7

(51) Int. Cl. F16H 3/20

(52) U.S. Cl. 74/331

(57) ABSTRACT

A double clutch transmission with inputs of two clutches (K1, K2) connected to a drive shaft (wan) and output sides connected to a respective transmission input shaft (w_k1 or w_k2) positioned coaxially to each other, at least two countershafts (w_v1, w_v2) each having toothed idler gearwheels (7, 9, 13, 14, 15, 16, 17, 18), toothed fixed gearwheels (1, 2, 3, 4, 5, 6) are positioned in a fixed manner on the two transmission input shafts (w_k1, w_k2), at least one shift element (N) is provided for connecting two toothed gear wheels with one another so that a plurality of power-shiftable forward gears (1, 2, 3, 4, 5, 6, 7, 8) and a shiftable reverse gear (R1, R2) is provided. A maximum of six gear planes (7-13, 2-14, 9-15, 4-16, 5-17, 6-18) are provided so that at least one power-shiftable winding path gear (G1, R2, O1) is shiftable by the shift element (N).

This application claims priority from German patent application serial no. 10 2009 002 357.7 filed Apr. 14, 2009.

### FIELD OF THE INVENTION

The present invention relates to a double clutch transmission.

### BACKGROUND OF THE INVENTION

A six-speed or seven-speed double clutch transmission is known from published patent DE 103 05 241 A1. The double clutch transmission comprises two clutches, each of which is connected on its input side to the drive shaft, and on its output side to one of the two transmission input shafts. The two transmission input shafts are placed coaxially relative to each other. Furthermore, two countershafts are situated axially parallel to the two transmission input shafts, with their idler gears engaging fixed gears of the transmission input shafts. Moreover, coupling devices are held on countershafts so that they are axially movable and rotationally fixed in order to be able to shift the respective toothed gearwheels. The chosen transmission ratio is transmitted to a differential through the output gears. In order to realize the desired transmission ratio stages with the known double clutch transmission, a large number of gear planes are necessary so that the construction space required for installation is not insignificant.

Furthermore, a spur-gear multi-speed transmission is known from published patent DE 38 22 330 A1. The spur-gear multi-speed transmission comprises a double clutch that is shiftable under load, one part of which is connected to a driveshaft, and the other part of which is connected to a hollow driveshaft that is rotatably carried on the driveshaft. For certain transmission ratios, the driveshaft can be coupled with the hollow driveshaft by means of a shift element.

From published patent DE 10 2004 001 961 A1, a power-shift transmission with two clutches is known, each of which is assigned to a subtransmission. The transmission input shafts of the two subtransmissions are placed coaxially to each other and are engaged with idler gears of the assigned countershafts through fixed gears. The respective idler gears of the countershafts can be connected, in a rotationally fixed manner, with the respective countershaft by means of assigned shift elements. From this published patent, an eight-speed transmission is known, in which an additional shift element is provided for coupling the two transmission input shafts to realize an additional transmission ratio stage. Even the seven-speed transmission, in this embodiment, requires at least six gear planes in the two subtransmissions in order to be able to realize the transmission ratio stages. This results in an undesirable lengthening of the construction length, in the axial direction, so that the possibility of installation in a vehicle is significantly limited.

Furthermore, from published patent DE 10 2005 028 532 A1, an additional power-shift transmission is known, which includes two input shafts and only one countershaft. For example, an eight-speed transmission in this embodiment requires more than seven gear planes in order to be able to realize the transmission ratio stages including, in particular, the reverse gear transmission ratios. This results in an undesirable lengthening of the construction length in the axial direction.

### SUMMARY OF THE INVENTION

The object of the present invention is to propose a double clutch transmission of the species described at the beginning, wherein a plurality of power-shiftable transmission ratio stages are realized as economically as possible and with the fewest possible parts while requiring little construction space.

Accordingly, a construction-space-optimized double clutch transmission with two clutches is proposed, whose input sides are connected to a drive shaft, and whose output sides are each connected to one of two transmission input shafts, for example, which are situated coaxially to each other. The double clutch transmission comprises at least two countershafts or the like, on which toothed gearwheels, designed as idler gears, are rotatably carried, there being toothed gearwheels designed as fixed gears, at least part of which are engaged with idler gears, placed in a rotationally fixed manner on the two transmission input shafts. A number of coupling devices are also provided for connecting an idler gear in a rotationally fixed manner to a countershaft. The double clutch transmission, according to the invention, has an output gear or constant pinion on each of the countershafts, each of which is coupled with gearing of a drive shaft in order to connect the respective countershaft with the output drive, and at least one shift element for connecting two toothed gearwheels in a rotationally fixed manner, thus making a plurality of power-shiftable gears feasible.

According to the invention, the proposed double clutch transmission preferably comprises a maximum of six gear planes, with which at least eight power-shiftable gears are realized with little construction space required. For example, one way in which the maximum of six gear planes can be formed is preferably by at least two dual gear planes and at least three single gear planes. Other constellations are also possible. In each dual gear plane, one idler gear of the first and second countershafts each is assigned to a fixed gear of one of the transmission input shafts, and with at least one of the dual gear planes, at least one idler gear is usable for at least two gear speeds. With the single gear planes, an idler gear of one of the countershafts is assigned to a fixed gear of one of the transmission input shafts. With the proposed double clutch transmission, at least one winding path gear is shiftable by means of a respective winding path gear shift element.

Because of the possible multiple use of idler gears, it is possible to realize with the proposed double clutch transmission a maximum number of gear ratios with the fewest possible gear planes, with preferably the first eight forward gears being power-shiftable with a sequential design.

To optimize the stepping in the double clutch transmission proposed according to the invention, it is also possible to replace a dual gear plane with two single gear planes, for example, by replacing one fixed gear with two fixed gears. This makes it possible to achieve especially harmonic, progressive gear stepping. It is also possible to replace two single gear planes with one dual gear plane.

The proposed double clutch transmission can preferably be designed as an 8-speed transmission with at least eight power-shiftable gear steps. However, transmissions with other numbers of speeds can also be realized. Because of the short construction, compared to known transmission arrangements, the double clutch transmission, according to the invention, is especially suited for a front transverse design in a vehicle. However, other types of installations are also possible, depending on the type and construction space situation of the vehicle in question.

Preferably, in the proposed double clutch transmission, the first or the eighth forward gear can be a winding path gear. In addition, a reverse gear and/or other gears, such as crawler gears or overdrive gears, for example, can also be designed as winding path gear, and may possibly also be power-shiftable. For example, the first power-shiftable forward gear or the highest power-shiftable gear may be a winding path gear.

In the proposed double clutch transmission, at least one winding path gear shift element may be assigned to at least one countershaft to realize the winding path gears. Optionally, additional winding path gear shift elements can also be provided, for example, in form of a shift element assigned to the first or second countershaft, or also in form of winding path gear coupling devices, which are quasi assigned to the constant pinions as winding path gear shift elements to detach the constant pinions from the assigned countershaft in order to be able to realize additional winding path gears. Thus, both constant pinions are optionally shiftably connected to the assigned countershaft.

For example, depending on the embodiment, it is possible to assign two to six shiftable idler gears to first countershaft and, for example, to assign three to six shiftable idler gears to the second countershaft, each of them engaging with fixed gears of the assigned transmission input shafts.

If the last or next-to-last gear increment is designed higher than the respective one before it, an especially high output torque or drive power can be made available when the driver requests a downshift.

According to the invention, provision can be made for idler gear of the second subtransmission to be connectable with the idler gear of the first subtransmission through the at least one additional shift element or through at least one additional shift element on the first and/or second countershaft, so that at least one winding path gear can be shifted by means of the shift element.

With the double clutch transmission according to the invention, it is thus possible, with an activated shift element and, if necessary, in addition with disengaged coupling devices on the output gears, to realize winding path gears, in which toothed gearwheels of both subtransmissions are coupled with each other in order to thereby realize a flow of power through both subtransmissions. The particular winding gear shift element serves, in this case, to couple two idler gears, and thereby brings the transmission input shafts into dependency on each other.

In the double clutch transmission, the arrangement of the shift elements for coupling two particular idler gears can be varied so that the shift elements do not necessarily have to be placed between idler gears that are to be coupled. Accordingly, other arrangement positions of the particular shift element are also conceivable in order to optimize, for example, the linking to an actuator system.

Optionally, with the proposed double clutch transmission, provision can be made for at least one additional gear step ZW_x, which is not used with any other forward gear.

A possible embodiment of the invention may provide that a first gear plane is assigned as a dual gear plane, a second gear plane is assigned as a single gear plane, and a third gear plane is assigned as a dual gear plane to the fixed gears of the second transmission input shaft of the second subtransmission; and that a fourth gear plane is assigned as a single gear plane, a fifth gear plane is assigned as a single gear plane, and a sixth gear plane is assigned as a single gear plane to the fixed gears of the first transmission input shaft of the first subtransmission.

In the scope of a further embodiment of the invention, for example, it may also be provided that a first gear plane is assigned as a single gear plane, a second gear plane is assigned as a single gear plane, and a third gear plane is assigned as a dual gear plane to the fixed gears of the second transmission input shaft of the second subtransmission; and that a fourth gear plane is assigned as a dual gear plane, a fifth gear plane is assigned as a single gear plane, and a sixth gear plane is assigned as a single gear plane to the fixed gears of the first transmission input shaft of the second subtransmission.

According to the invention, it may be provided that a first gear plane is assigned as a single gear plane, a second gear plane is assigned as a dual gear plane, and a third gear plane is assigned as a dual gear plane to the fixed gears of second transmission input shaft of the second subtransmission; and that a fourth gear plane is assigned as a dual gear plane, a fifth gear plane is assigned as a single gear plane, and a sixth gear plane is assigned as a single gear plane to the fixed gears of the first transmission input shaft of the first subtransmission.

It is also possible to assign a first gear plane as a dual gear plane, a second gear plane as a single gear plane, and a third gear plane as a dual gear plane to the fixed gears of the second transmission input shaft of the second subtransmission; and to assign a fourth gear plane as a dual gear plane, a fifth gear plane as a single gear plane, and a sixth gear plane as a single gear plane to the fixed gears of the first transmission input shaft of the first subtransmission.

Possibly, a first gear plane can be assigned as a single gear plane, a second gear plane can be assigned as a single gear plane, and a third gear plane can be assigned as a dual gear plane to the fixed gears of the second transmission input shaft of the second subtransmission; whereas a fourth gear plane is assigned as a dual gear plane, a fifth gear plane is assigned as a dual gear plane, and a sixth gear plane is assigned as a single gear plane to the fixed gears of the first transmission input shaft (w_) of the second subtransmission.

A further modification of the invention may provide that a first gear plane is assigned as a single gear plane, a second gear plane is assigned as a single gear plane, and a third gear plane is assigned as a single gear plane to the fixed gears of the second transmission input shaft of the second subtransmission; and that a fourth gear plane is assigned as a dual gear plane, a fifth gear plane is assigned as a dual gear plane, and a sixth gear plane is assigned as a dual gear plane to the fixed gears of the first transmission input shaft of the second subtransmission.

In order to provide the necessary rotation reversal to realize reverse gears in the double clutch transmission according to the invention, it is possible to use at least one intermediate gear or the like, for example, which is situated on an intermediate shaft, for example. It is also possible for one of idler gears of a countershaft to serve as the intermediate gear wheel for at least one reverse gear. No additional intermediate shaft is then necessary for the reverse gear transmission because one of idler gears is engaged both with a fixed gear and with another shiftable idler gear of the other countershaft. Thus the necessary intermediate gear wheel, for the reverse gear, is positioned on a countershaft as a shiftable idler gear, and also serves to realize at least one additional forward gear. The intermediate gear can also be designed as a stepped gear, independent of whether it is placed on the countershaft or on an additional intermediate shaft. It is also possible for the intermediate gear to not be placed on one of the already existing countershafts but, for example, to be provided on another separate shaft, for example, a third countershaft.

In order to obtain the desired transmission ratio steps, it can also be provided in the double clutch transmission, according to the invention, that at least one bidirectionally operative coupling device or the like is situated on each countershaft. The provided coupling devices can each connect an assigned idler gear with the countershaft in a rotationally fixed manner in the activated or engaged state, depending on the direction of operation. In addition, a coupling device or the like operating on one side can also be provided on at least one of countershafts. The coupling devices used can be hydraulically, pneumatically, electrically or mechanically operated clutches, for example, or also form locking claw clutches as well as any type of synchronization that provides a rotationally fixed connection of an idler gear with a countershaft. It is possible for a bi-directionally operative coupling device to be replaced by two unidirectionally operative coupling devices, or vice versa.

It is conceivable that the indicated positioning options for the toothed gearwheels may be varied, and also that the number of toothed gearwheels and the number of coupling devices may be changed, in order to realize even more power-shiftable or non-power-shiftable gears, as well as to save construction space and parts in the proposed double clutch transmission. In particular, fixed gears of the dual gear planes can be divided into two fixed gears for two single gear planes. That makes it possible to improve step changes. In addition, it is possible to exchange countershafts. The subtransmissions can also be exchanged, i.e., they are mirrored around a vertical axis. In doing so, the hollow shaft and solid shaft are exchanged. This makes it possible to place the smallest gearwheel on the solid shaft, for example, in order to further optimize the utilization of the available construction space. In addition, neighboring gear planes can be exchanged, for example, to optimize shaft flexing and/or to link optimally a shift actuating system. Moreover, the respective placement position of the coupling devices at the gear plane can be varied. Furthermore, the direction of action of the coupling devices can also be changed.

The gear numberings used here were defined freely. It is also possible to add a crawler or a creeper gear and/or an overdrive or a fast gear, in order to improve the off-road properties or the acceleration behavior of a vehicle, for example. Furthermore, it is possible to omit a first gear, for example, in order to be able to better optimize the step changes overall. The gear numbering varies logically when these measures are used.

Independent of the respective variant embodiments of the double clutch transmission, the drive shaft and the output shaft may preferably also not be arranged coaxially to each other; this realizes an especially space-saving arrangement. For example, the shafts, which are thus positioned spatially one behind the other, may also be offset slightly relatively to each other. With this arrangement, a direct gear with a transmission ratio of one is realizable by means of tooth engagement, and can be advantageously shifted to the sixth through ninth gears relatively freely. Other possible arrangements of the drive shaft and output shaft are also conceivable.

Preferably, the proposed double clutch transmission is equipped with an integrated output stage. The output stage can include a fixed gear on the output shaft, as the output gear, which meshes both with a first output gear as a constant pinion of the first countershaft and also with a second output gear as a constant pinion of the second countershaft. Optionally, it is also possible to develop both output gears as shiftable gears. To shift the respective output gear, for example, there may be assigned a winding path gear coupling device which, in its disengaged state, releases the connection between the assigned countershaft and the output gear in order to be able to shift the winding path gears.

Advantageously, the lower forward gears and the reverse gears can be actuated by means of a start-up clutch or shifting a clutch in order to thereby concentrate higher loads on this clutch so that the second clutch can be designed for smaller construction space and lower cost. In particular, the gear planes can be arranged in the proposed double clutch transmission so that the vehicle can be set in motion either by means of the inner transmission input shaft or also the outer transmission input shaft, and thus by means of whichever clutch is better suited in the particular case; this is also possible with a concentrically arranged, radially nested construction of the double clutch. Furthermore, the gear planes may be correspondingly arranged mirror-symmetrically, or may be exchanged.

Independent of the respective variant embodiment, the provided gear planes may, for example, be exchanged in the double clutch transmission.

### BRIEF DESCRIPTION OF THE DRAWINGS

The present invention will be explained in greater detail below on the basis of the drawing. The figures show the following:

FIG. 1 a schematic view of a 1^{st} variant embodiment of an eight-speed double clutch transmission according to the invention;

FIG. 2 a shift pattern of the 1^{st} variant embodiment according to FIG. 1.

FIG. 3 a schematic view of a 2^{nd} variant embodiment of the eight-speed double clutch transmission according to the invention;

FIG. 4 a shift pattern of the 2^{nd} variant embodiment according to FIG. 3;

FIG. 5 a schematic view of a 3^{nd} variant embodiment of the eight-speed double clutch transmission according to the invention;

FIG. 6 a shift pattern of the 3^{rd} variant embodiment according to FIG. 5;

FIG. 7 a schematic view of a 4^{th} variant embodiment of the eight-speed double clutch transmission according to the invention;

FIG. 8 a shift pattern of the 4^{th} variant embodiment according to FIG. 7;

FIG. 9 a schematic view of a 5^{th} variant embodiment of the eight-speed double clutch transmission according to the invention;

FIG. 10 a shift pattern of the 5^{th} variant embodiment according to FIG. 9;

FIG. 11 a schematic view of a 6^{th} variant embodiment of the eight-speed double clutch transmission according to the invention;

FIG. 12 a shift pattern of the 6^{th} variant embodiment according to FIG. 11;

FIG. 13 a schematic view of a 7^{th} variant embodiment of the eight-speed double clutch transmission according to the invention;

FIG. 14 a shift pattern of the 7^{th} variant embodiment according to FIG. 13;

FIG. 15 a schematic view of an 8^{th} variant embodiment of the eight-speed double clutch transmission according to the invention;

FIG. 16 a shift pattern of the 8^{th} variant embodiment according to FIG. 15;

FIG. 17 a schematic view of a 9^{th} variant embodiment of the eight-speed double clutch transmission according to the invention;

FIG. 18 a shift pattern of the 9^{th} variant embodiment according to FIG. 17;

FIG. 19 a schematic view of a 10^{th} variant embodiment of the eight-speed double clutch transmission according to the invention;

FIG. 20 a shift pattern of the 10^{th} variant embodiment according to FIG. 19;

FIG. 21 a schematic view of an 11^{th} variant embodiment of the eight-speed double clutch transmission according to the invention;

FIG. 22 a shift pattern of the 11^{th} variant embodiment according to FIG. 21;

FIG. 23 a schematic view of a 12^{th} variant embodiment of the eight-speed double clutch transmission according to the invention;

FIG. 24 a shift pattern of the 12^{th} variant embodiment according to FIG. 23;

FIG. 25 a schematic view of a 13^{th} variant embodiment of the eight-speed double clutch transmission according to the invention;

FIG. 26 a shift pattern of the 13^{th} variant embodiment according to FIG. 25;

FIG. 27 a schematic view of a 14^{th} variant embodiment of the eight-speed double clutch transmission according to the invention;

FIG. 28 a shift pattern of the 14^{th} variant embodiment according to FIG. 27,

FIG. 29 a schematic view of a 15^{th} variant embodiment of the eight-speed double clutch transmission according to the invention; and

FIG. 30 a shift pattern of the 15^{th} variant embodiment according to FIG. 29.

### DETAILED DESCRIPTION OF THE PREFERRED EMBODIMENTS

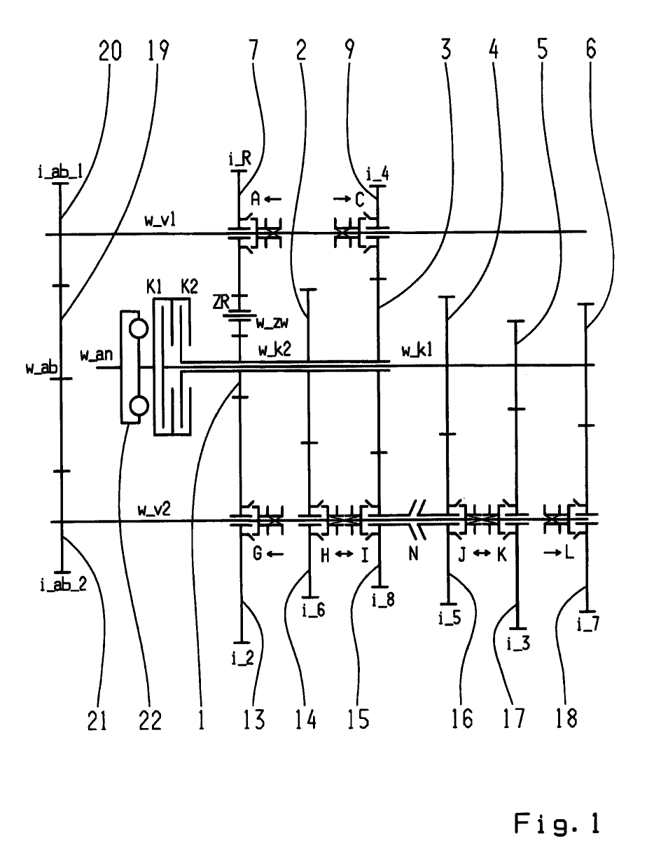

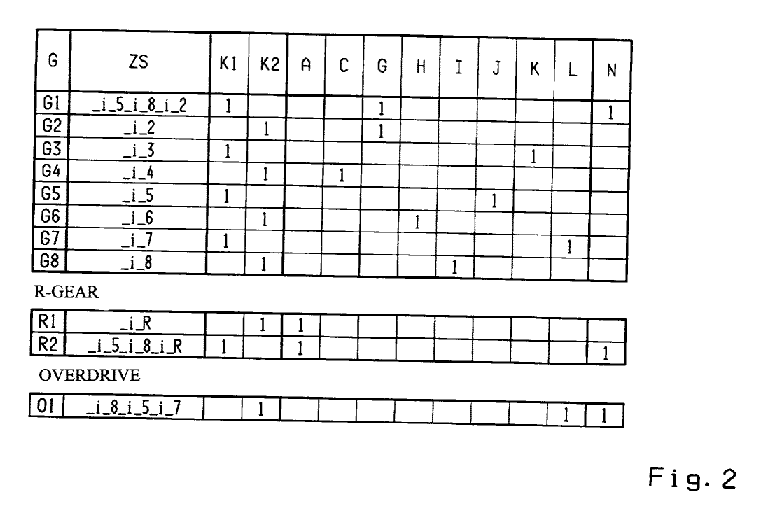

FIGS. 1, 3, 5, 7, 9, 11, 13, 15, 17, 19, 21, 23, 25, 27 and 29 each show a possible variant embodiment of an eight-speed double clutch transmission. The respective shift patterns for the different variant embodiments are depicted in chart form in FIGS. 2, 4, 6, 8, 10, 12, 14, 16, 18, 20, 22, 24, 26, 28 and 30.

The eight-speed double clutch transmission comprises two clutches K1, K2, whose input sides are connected to a drive shaft w_an and whose output sides are each connected to one of two respective transmission input shafts w_k1, w_k2, which are arranged coaxially with each other. In addition, a torsion vibration damper 22 can be placed on the drive shaft w_an. Furthermore, two countershafts w_v1, w_v2 are provided on which toothed gear wheels, in the form of idler gears 7, 8, 9, 10, 11, 12, 13, 14, 15, 16, 17, 18, are rotatably supported. Placed on the two transmission input shafts w_k1, w_k2 are rotationally fixed toothed gearwheels, designed as fixed gears 1, 2, 3, 4, 5, 6, at least part of which mesh with the idler gears 7, 8, 9, 10, 11, 12, 13, 14, 15, 16, 17, 18.

In order to be able to connect the idler gears 7, 8, 9, 10, 11, 12, 13, 14, 15, 16, 17, 18 with the respective countershaft w_v1, w_v2, a plurality of activatable coupling devices A, B, C, D, E, F, G, H, I, J, K, L are provided on the countershafts w_v1, w_v2. Furthermore, output gears 20, 21, each of which is coupled with toothing of a fixed gear 19 of an output shaft w_ab, with corresponding output stages i_ab_1, i_ab_2 assigned to the output gears 20, 21, are situated on the two countershafts w_v1, w_v2 as constant pinions.

Besides coupling devices A, B, C, D, E, F, G, H, I, J, K, L, which in the activated state realize a rotationally fixed connection between a toothed gearwheel and the assigned countershaft wv1, w_v2 , a winding path gear shift element M is provided on the first countershaft w_v1, w_v2.

The shift element N connects the idler gears 15 and 16 of the second countershaft w_v2, in order to couple the first subtransmission with the second subtransmission, so that winding path gears can be shifted. Optionally, it is also possible to use a shift element M to connect the idler gears 9 and 10 of first countershaft w_v1, in order to couple the first subtransmission with the second subtransmission, so that additional winding path gears can be shifted.

According to the invention, six gear planes 7-1, 1-13, 7-13, 8-2, 2-14, 8-14, 3-15, 9-15, 4-16, 10-16, 11-5, 5-17, 11-17, 6-18, 12-6, 12-18 are provided in the double clutch transmission, with at least two dual gear planes 7-13, 8-14, 9-15, 10-16, 11-17, 12-18 and at least three single gear planes 7-1, 1-13, 8-2, 2-14, 3-15, 4-16, 11-5, 5-17, 6-18, 12-6 provided in each variant embodiment, so that winding path gears are shiftable at least when the shift element N is activated. A claw or the like for connecting two gearwheels or the like, for example, may be used as each of the shift elements M or N.

In the first and second variant embodiments according to FIGS. 1 to 4, with the first gear plane 7-13, as a dual gear plane, fixed gear 1 of second transmission input shaft w_k2 meshes with idler gear 13 of second countershaft w_v2 and with an intermediate gear ZR on an intermediate shaft w_zw to reverse the rotation for the reverse gear transmission ratios, with the intermediate gear ZR also meshing with idler gear 7 of first countershaft w_v1. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 4-16, as a single gear plane, fixed gear 4 of first transmission input shaft w_k1 meshes with idler gear 16 of second countershaft w_v2. In the fifth gear plane 5-17, as a single gear plane, fixed gear 5 of first transmission input shaft w_k1 meshes with idler gear 17 of second countershaft w_v2. In the sixth gear plane 6-18, as a single gear plane, fixed gear 6 of first transmission input shaft w_k1 meshes with idler gear 18 of second countershaft w_v2.

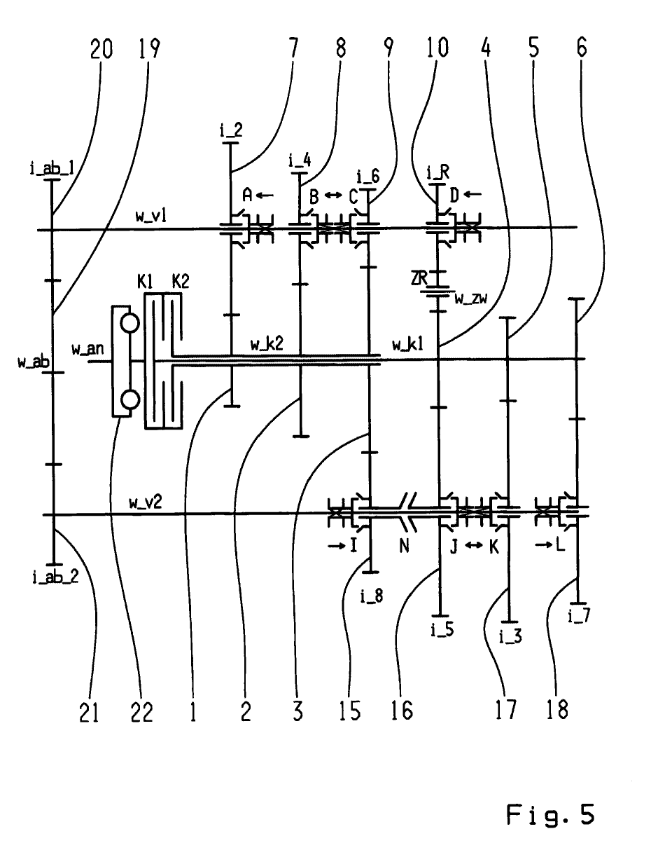

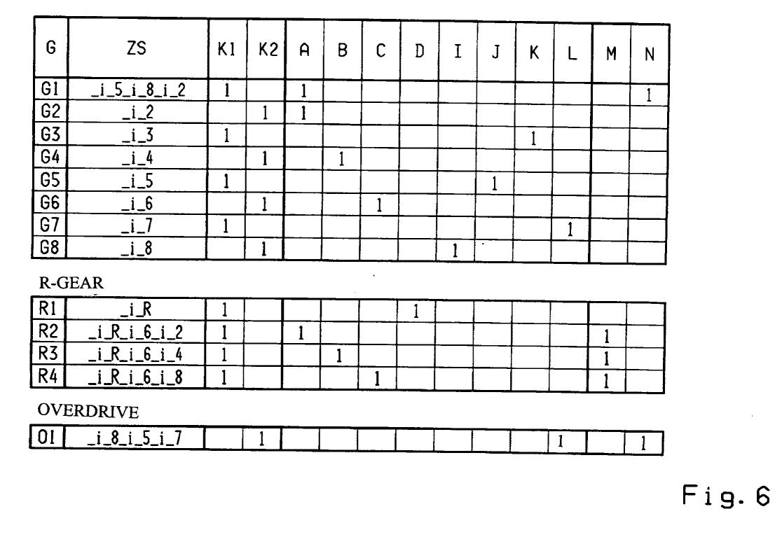

In the third variant embodiment according to FIGS. 5 and 6, in the first gear plane 7-1, as a single gear plane, fixed gear 1 of second transmission input shaft w_k2 meshes with idler gear 7 of first countershaft w_v1. In the second gear plane 8-2, as a single gear plane, fixed gear 2 of second transmission input shaft w_v2 meshes with idler gear 8 of first countershaft w_v1. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 16 of second countershaft w_v2 and with intermediate gear ZR, to reverse the rotation for the reverse gear transmission ratios, with intermediate gear ZR also meshing with idler gear 10 of first countershaft w_v1. In the fifth gear plane 5-17, as a single gear plane, fixed gear 5 of first transmission input shaft w_k1 meshes with idler gear 17 of second countershaft w_v2. Finally, in the sixth gear plane 6-18, as a single gear plane, fixed gear 6 of first transmission input shaft w_k1 meshes with idler gear 18 of second countershaft w_v2.

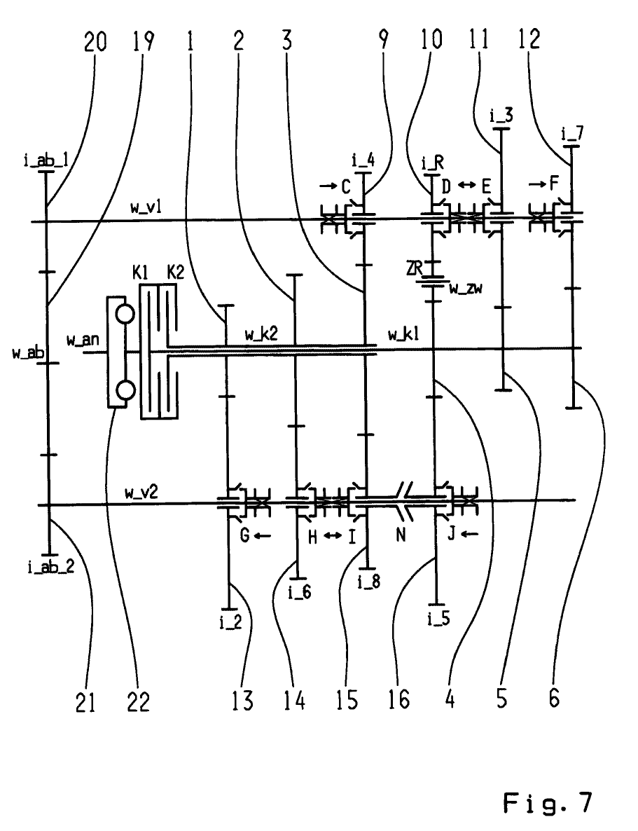

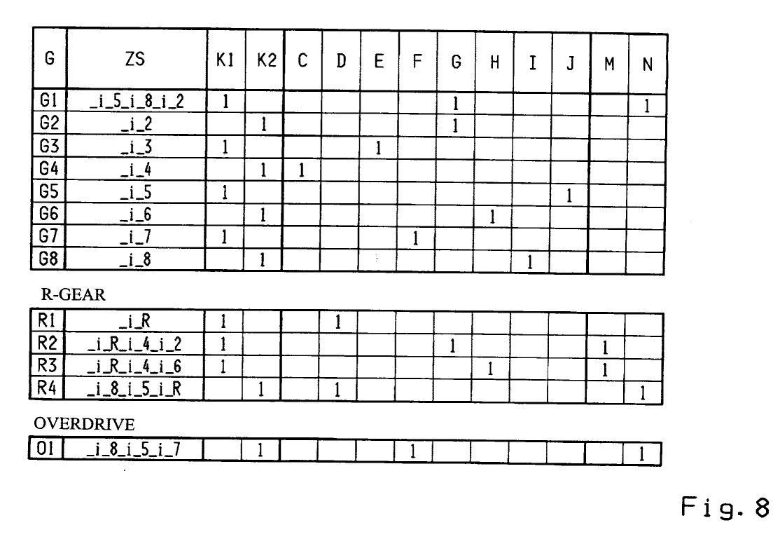

In the fourth variant embodiment according to FIGS. 7 and 8, in the first gear plane 1-13, as a single gear plane, fixed gear 1 of second transmission input shaft w_k2 meshes with idler gear 13 of second countershaft w_v2. In the second gear plane 2-14, as a single gear plane, fixed gear 2 of second transmission input shaft w_v2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 16 of second countershaft w_v2 and with intermediate gear ZR, to reverse the rotation for the reverse gear transmission ratios, with intermediate gear ZR also meshing with idler gear 10 of first countershaft w_v1. In the fifth gear plane 11-5, as a single gear plane, fixed gear 5 of first transmission input shaft w_k1 meshes with idler gear 11 of first countershaft w_v1. Finally, in the sixth gear plane 12-6, as a single gear plane, fixed gear 6 of first transmission input shaft w_k1 meshes with idler gear 12 of first countershaft w_v1.

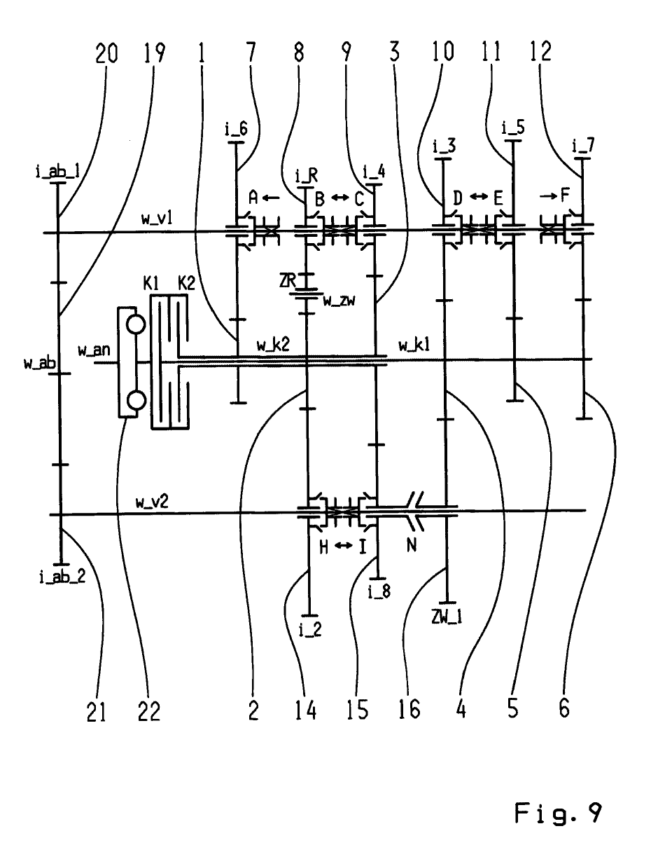

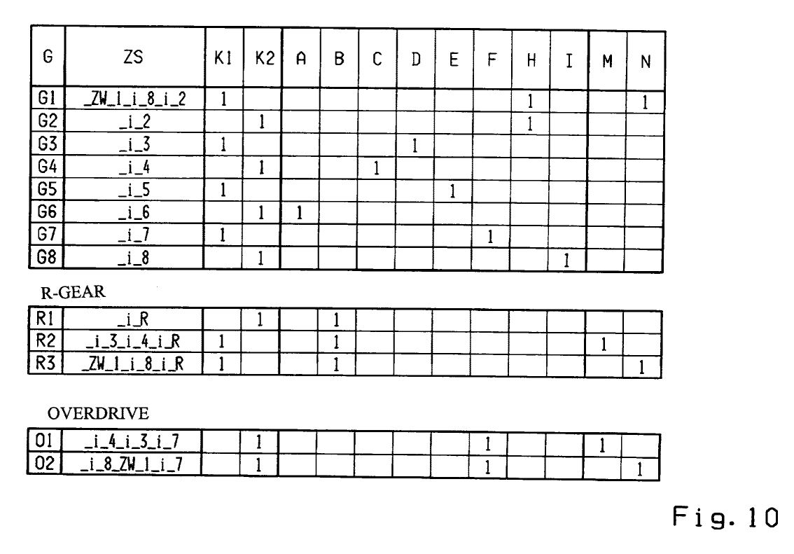

In the fifth variant embodiment according to FIGS. 9 and 10, in the first gear plane 7-1, as a single gear plane, fixed gear 1 of second transmission input shaft w_k2 meshes with idler gear 7 of first countershaft w_v1. In the second gear plane 8-14, as a dual gear plane, fixed gear 2 of second transmission input shaft w_v2 meshes with idler gear 14 of second countershaft w_v2 and with intermediate gear ZR, to reverse the rotation for the reverse gear transmission ratios, with intermediate gear ZR also meshing with idler gear 8 of first countershaft w_v1. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 10 of first countershaft w_v1 and with idler gear 16 of second countershaft w_v2. In the fifth gear plane 11-5, as a single gear plane, fixed gear 5 of first transmission input shaft w_k1 meshes with idler gear 11 of first countershaft w_v1. Finally, in the sixth gear plane 12-6, as a single gear plane, fixed gear 6 of first transmission input shaft w_k1 meshes with idler gear 12 of first countershaft w_v1.

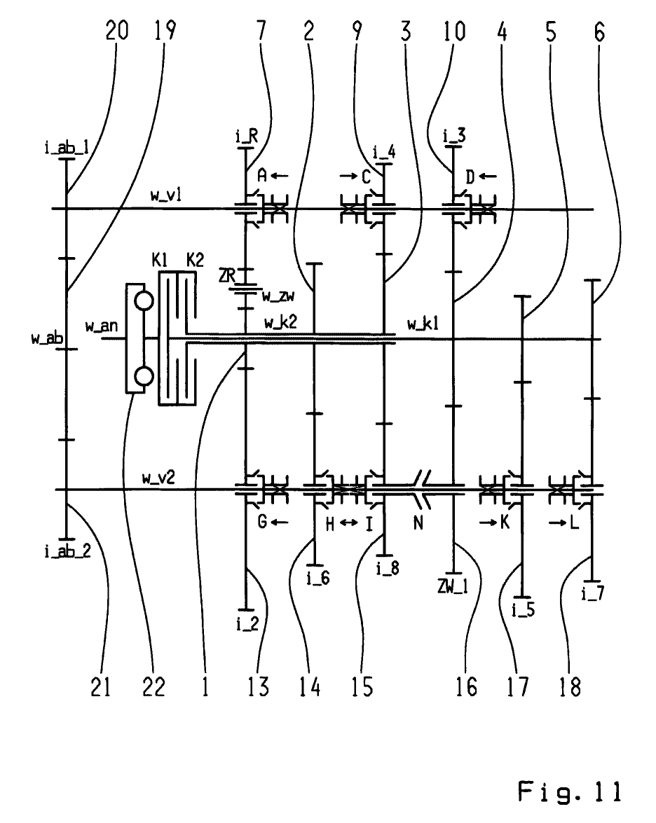

In the sixth and seventh variant embodiment according to FIGS. 11 to 14, in the first gear plane 7-13, as a dual gear plane, fixed gear 1 of second transmission input shaft w_k2 meshes with idler gear 13 of second countershaft w_v2 and with intermediate gear ZR on the intermediate shaft w_zw, to reverse the rotation for the reverse gear ratios, with intermediate gear ZR also meshing with idler gear 7 of first countershaft w_v1. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with both idler gear 10 of first countershaft w_v1 and with idler gear 16 of second countershaft w_v2. In the sixth variant embodiment, in the fifth gear plane 5-17, as a single gear plane, fixed gear 5 of first transmission input shaft w_k1 meshes with idler gear 17 of second countershaft w_v2, and in the sixth gear plane 6-18, as a single gear plane, fixed gear 6 of first transmission input shaft w_k1 meshes with idler gear 18 of second countershaft w_v2. On the other hand, in the seventh variant embodiment, in the fifth gear plane 11-5, as a single gear plane, fixed gear 5 of first transmission input shaft w_k1 meshes with idler gear 11 of first countershaft w_v1 and in sixth gear plane 12-6, as a single gear plane, fixed gear 6 of first transmission input shaft w_k1 meshes with idler gear 12 of first countershaft wv1

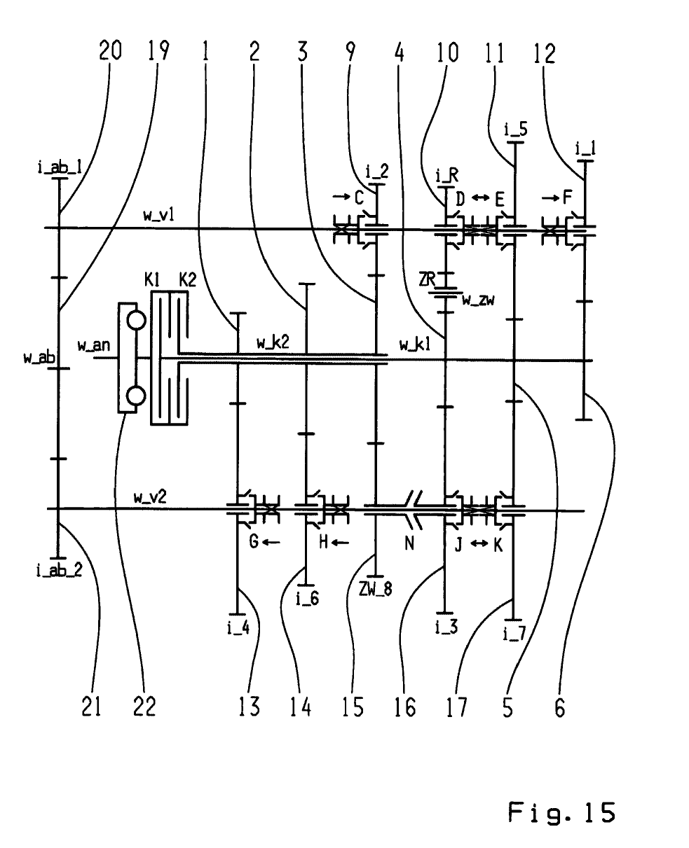

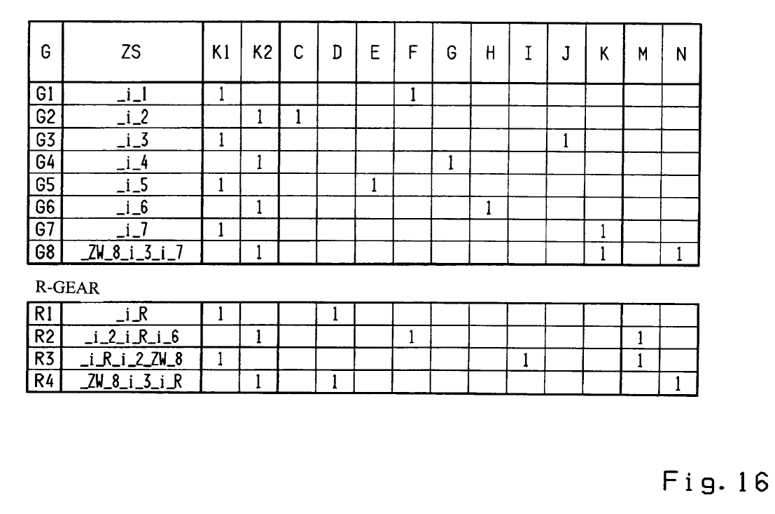

In the eighth variant embodiment according to FIGS. 15 and 16, in the first gear plane 1-13, as a single gear plane, fixed gear 1 of second transmission input shaft w_k2 meshes with idler gear 13 of second countershaft w_v2. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 16 of second countershaft w_v2 and with intermediate gear ZR, to reverse the rotation for the reverse gear ratios, with intermediate gear ZR also meshing with idler gear 10 of first countershaft w_v1. In the fifth gear plane 11-17, as a dual gear plane, fixed gear 5 of first transmission input shaft w_k1 meshes with both idler gear 11 of first countershaft w_v1 and with idler gear 17 of second countershaft w_v2. Finally, in the sixth gear plane 12-6, as a single gear plane, fixed gear 6 of first transmission input shaft w_k1 meshes with idler gear 12 of first countershaft w_v1.

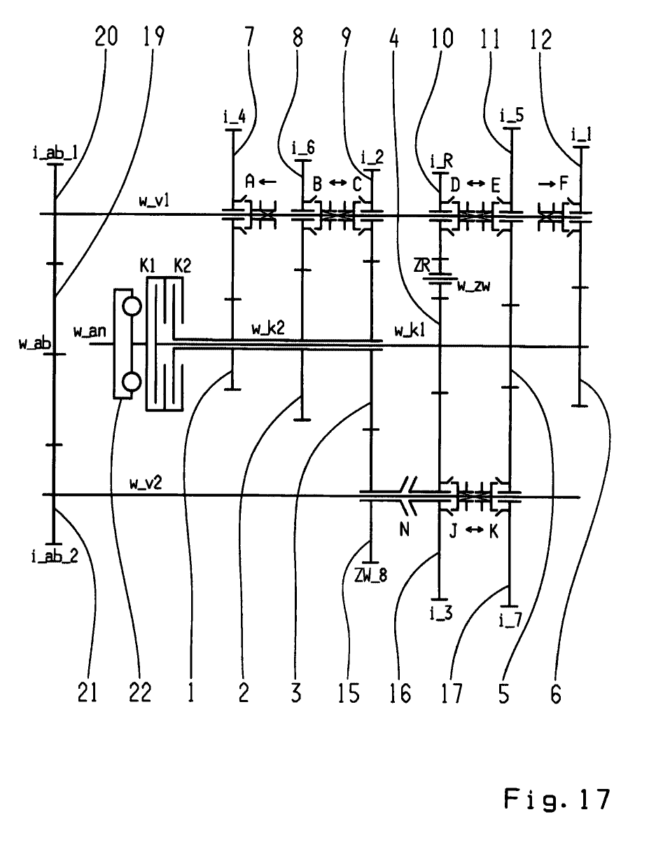

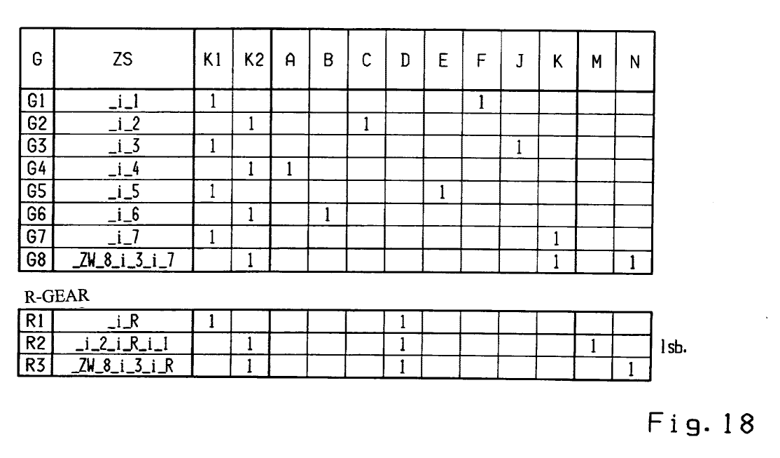

In the ninth variant embodiment according to FIGS. 17 and 18, in the first gear plane 7-1, as a single gear plane, fixed gear 1 of second transmission input shaft w_k2 meshes with idler gear 7 of first countershaft w_v1. In the second gear plane 8-2, as a single gear plane, fixed gear 2 of second transmission input shaft w_k2 meshes with idler gear 8 of first countershaft w_v1. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 16 of second countershaft w_v2 and with intermediate gear ZR, to reverse the rotation for the reverse gear ratios, with intermediate gear ZR also meshing with idler gear 10 of first countershaft w_v1. In the fifth gear plane 11-17, as a dual gear plane, fixed gear 5 of first transmission input shaft w_k1 meshes with both idler gear 11 of first countershaft w_v1 and with idler gear 17 of second countershaft w_v2. Finally, in the sixth gear plane 12-6, as a single gear plane, fixed gear 6 of first transmission input shaft w_k1 meshes with idler gear 12 of first countershaft w_v1.

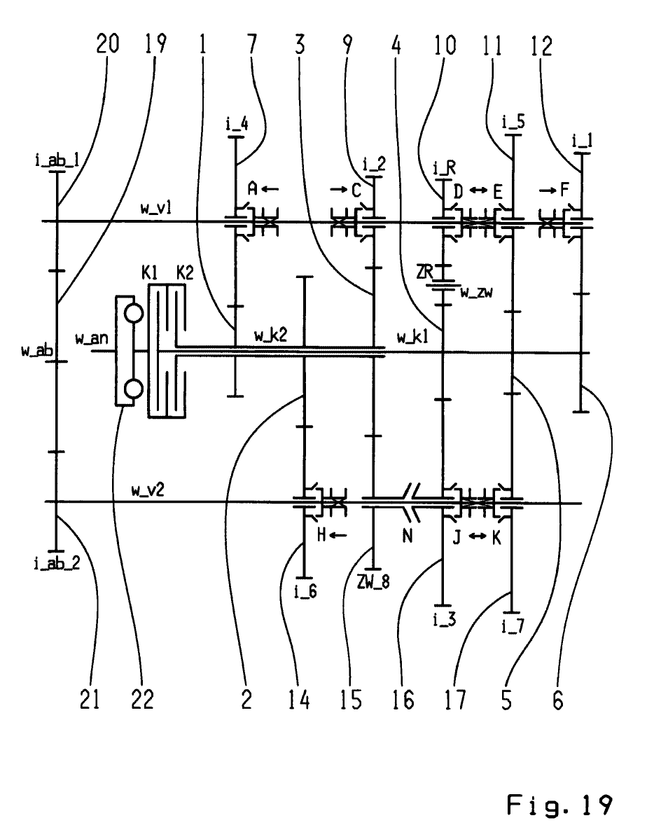

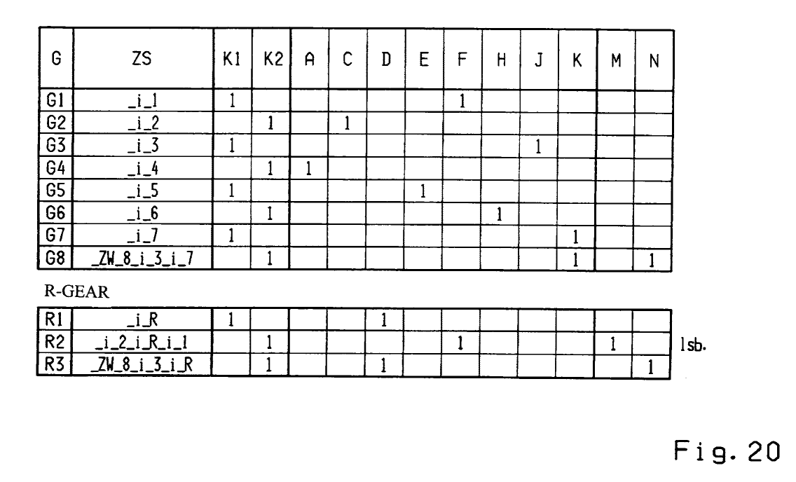

In the 10^{th} variant embodiment according to FIGS. 19 and 20, in the first gear plane 7-1, as a single gear plane, fixed gear 1 of second transmission input shaft w_k2 meshes with idler gear 7 of first countershaft wv1. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with idler gear 16 of second countershaft w_v2 and with intermediate gear ZR, to reverse the rotation for the reverse gear ratios, with intermediate gear ZR also meshing with idler gear 10 of first countershaft w_v1. In the fifth gear plane 11-17, as a dual gear plane, fixed gear 5 of first transmission input shaft w_k1 meshes with both idler gear 11 of first countershaft w_v1 and with idler gear 17 of second countershaft w_v2. Finally, in the sixth gear plane 12-6, as a single gear plane, fixed gear 6 of first transmission input shaft w_k1 meshes with idler gear 12 of first countershaft w_v1.

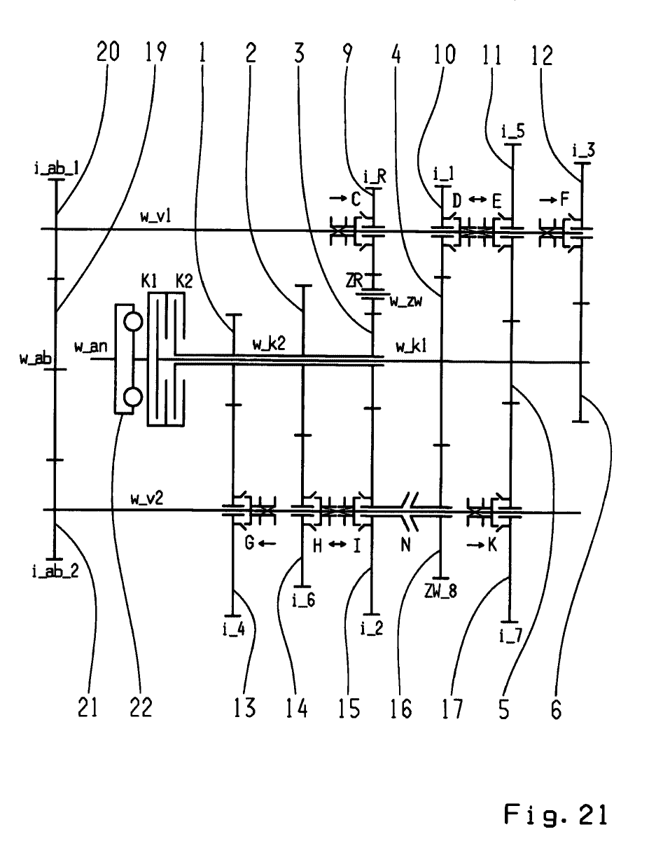

In the 11^{th} and 12^{th} variant embodiments according to FIGS. 21 to 24, in the first gear plane 1-13, as a single gear plane, fixed gear 1 of second transmission input shaft w_k2 meshes with idler gear 13 of second countershaft w_v2. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 15 of second countershaft w_v2 and with intermediate gear ZR, to reverse the rotation for the reverse gear ratios, with intermediate gear ZR also meshing with idler gear 9 of first countershaft w_v1. In the fourth gear plane 10-16, as a dual gear plane, fixed gear 4 of first transmission input shaft w_k1 meshes with idler gear 10 of first countershaft w_v1 and with idler gear 16 of second countershaft w_v2. In the fifth gear plane 11-17, as a dual gear plane, fixed gear 5 of first transmission input shaft w_k1 meshes with both idler gear 11 of first countershaft w_v1 as well as with idler gear 17 of second countershaft w_v2. In the eleventh variant embodiment, in the sixth gear plane 12-6, as a single gear plane, fixed gear 6 of first transmission input shaft w_k1 meshes with idler gear 12 of first countershaft w_v1. On the other hand, in the twelfth variant embodiment, with the sixth gear plane 6-18, as a single gear plane, fixed gear 6 of first transmission input shaft w_k1 meshes with idler gear 18 of second countershaft w_v2.

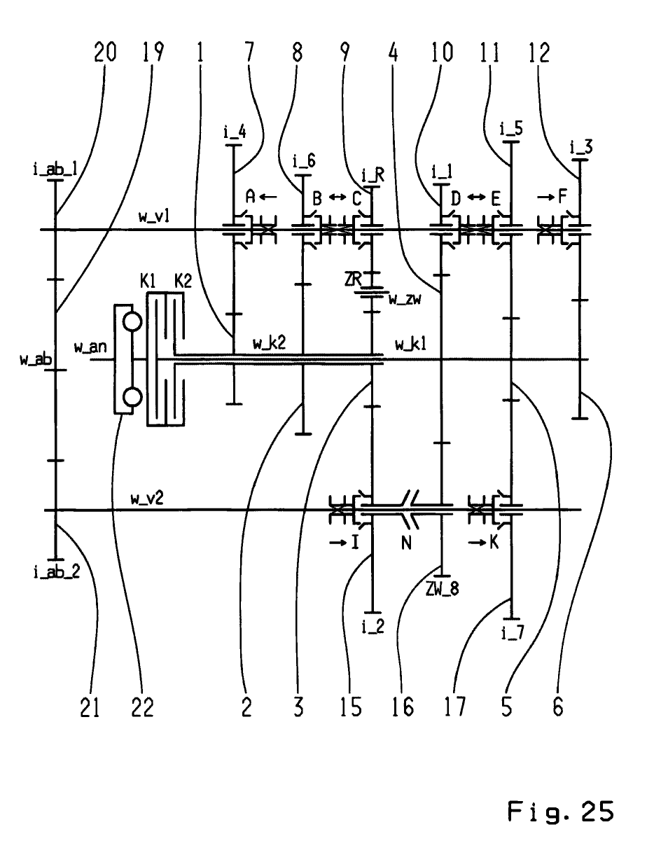

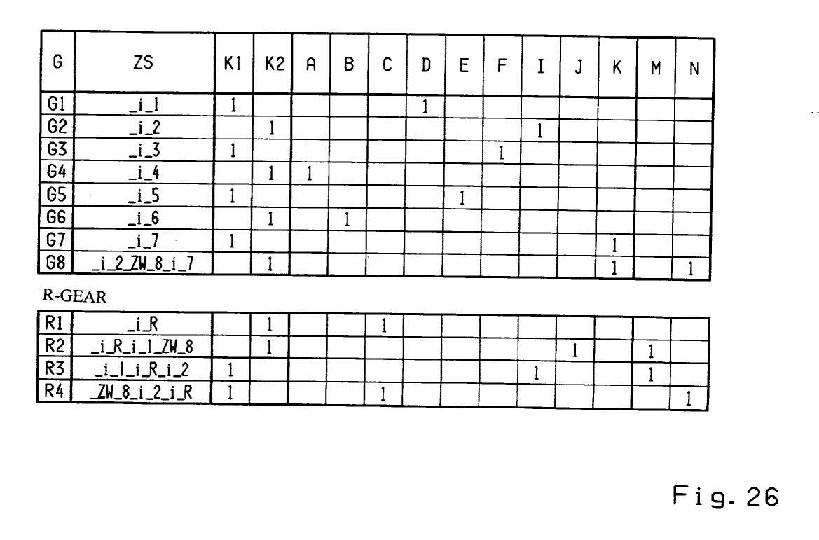

In the 13^{th} variant embodiment according to FIGS. 25 to 26, in the first gear plane 7-1, as a single gear plane, fixed gear 1 of second transmission input shaft w_k2 meshes with idler gear 7 of first countershaft w_v1. In the second gear plane 8-2, as a single gear plane, fixed gear 2 of second transmission input shaft w_k2 meshes with idler gear 8 of first countershaft w_v1. In the third gear plane 9-15, as a dual gear plane, fixed gear 3 of second transmission input shaft w_k2 meshes with both idler gear 15 of second countershaft w_v2 and with intermediate gear ZR, to reverse the rotation for the reverse gear ratios, with intermediate gear ZR also meshing with idler gear 9 of first countershaft w_v1. In the fourth gear plane 10-16, as a dual gear plane, fixed gear 4 of first transmission input shaft w_k1 meshes with idler gear 10 of first countershaft w_v1 and with idler gear 16 of second countershaft w_v2. In the fifth gear plane 11-17, as a dual gear plane, fixed gear 5 of first transmission input shaft w_k1 meshes with both idler gear 11 of first countershaft w_v1 and with idler gear 17 of second countershaft w_v2. In the sixth gear plane 12-6, as a single gear plane, fixed gear 6 of first transmission input shaft w_k1 meshes with idler gear 12 of first countershaft w_v1.

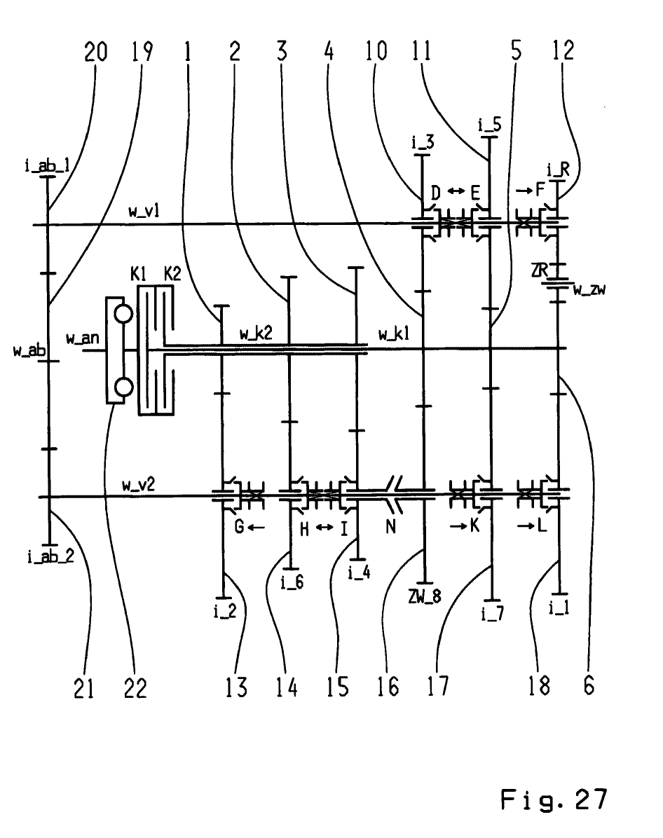

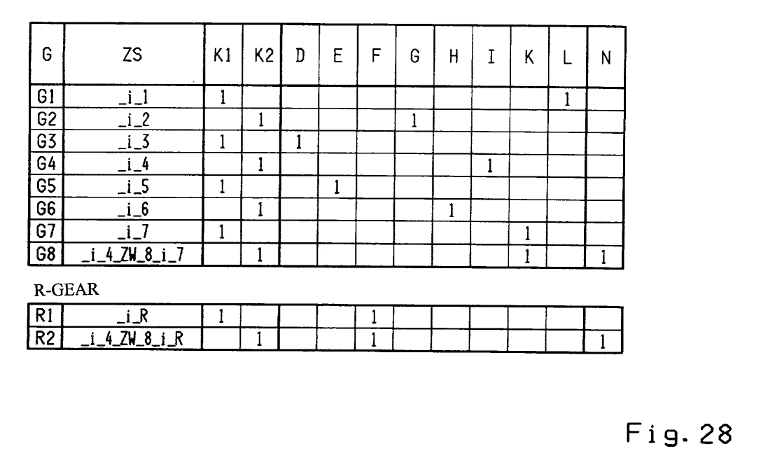

In the 14^{th} variant embodiment according to FIGS. 27 to 28, in the first gear plane 1-13, as a single gear plane, fixed gear 1 of second transmission input shaft w_k2 meshes with idler gear 13 of second countershaft w_v2. In the second gear plane 2-14, as a single gear plane, fixed gear 2 of second transmission input shaft w_k2 meshes with idler gear 14 of second countershaft w_v2. In the third gear plane 3-15, as a single gear plane, fixed gear 3 of second transmission input shaft w_k2 meshes with idler gear 15 of second countershaft w_v2. In the fourth gear plane 10-16, as a dual gear plane, fixed gear 4 of first transmission input shaft w_k1 meshes with idler gear 10 of first countershaft w_v1 and with idler gear 16 of second countershaft w_v2. In the fifth gear plane 11-17, as a dual gear plane, fixed gear 5 of first transmission input shaft w_k1 meshes with both idler gear 11 of first countershaft w_v1 and with idler gear 17 of second countershaft w_v2. In the sixth gear plane 12-18, as a dual gear plane, fixed gear 6 of first transmission input shaft w_k1 meshes with idler gear 18 of second countershaft w_v2 and with intermediate gear ZR, to reverse the rotation for the reverse gear ratios, with intermediate gear ZR also meshing with idler gear 12 of first countershaft w_v1.

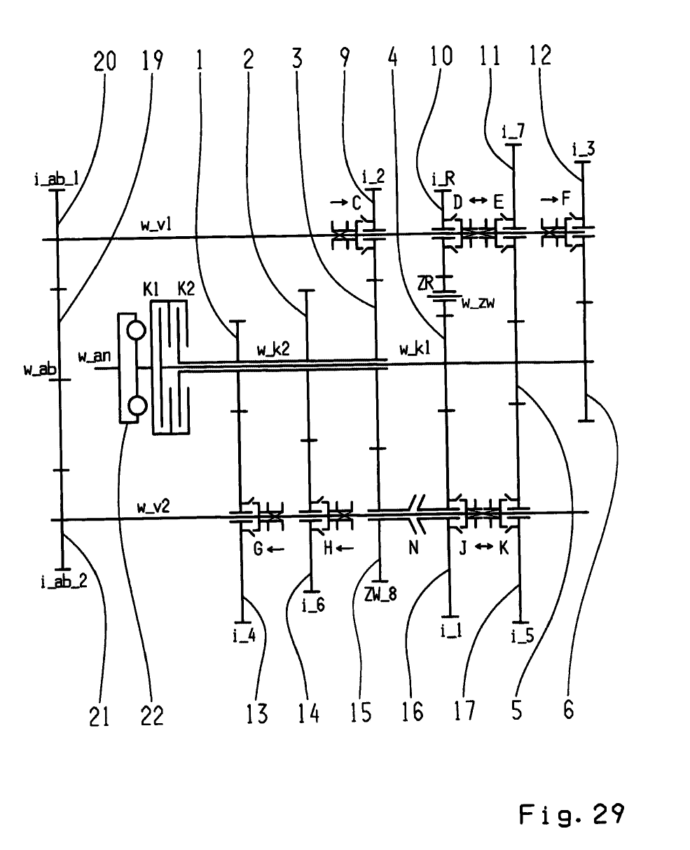

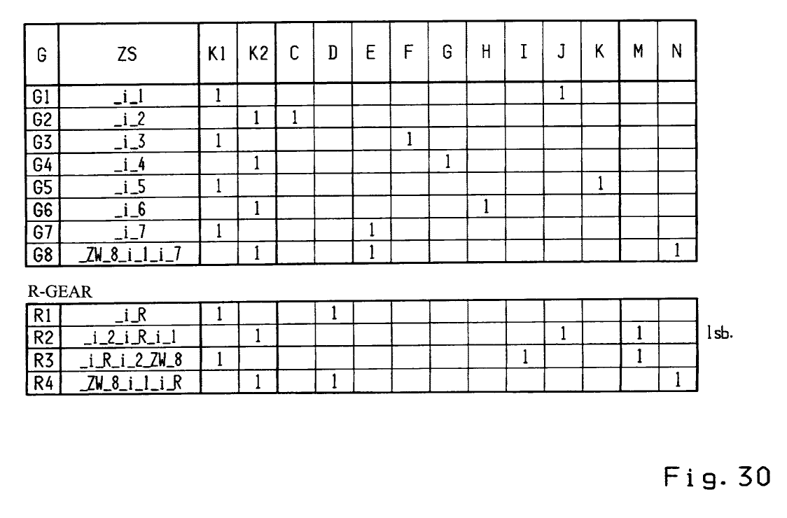

In the 15^{th} variant embodiment according to FIGS. 29 to 30, in the first gear plane 1-13, as a single gear plane, fixed gear 1 of second transmission input shaft w_k2 meshes with idler gear 13 of second countershaft w_v2. In the second gear plane 2-14, as a single gear plane, fixed gear 2 of second transmission input shaft w_k2 meshes with idler gear 14 of second countershaft w_v2. In the third gear plane 9-15, as a dual gear plane, fixed gear 3 of second transmission input shaft w_k2 meshes with both idler gear 9 of first countershaft w_v1 and with idler gear 15 of second countershaft w_v2. In the fourth gear plane 10-16, as a dual gear plane, fixed gear 4 of first transmission input shaft w_k1 meshes with both idler gear 16 of second countershaft w_v2 and with intermediate gear ZR, to reverse the rotation for the reverse gear ratios, with intermediate gear ZR also meshing with idler gear 10 of first countershaft w_v1. In the fifth gear plane 11-17, as a dual gear plane, fixed gear 5 of first transmission input shaft w_k1 meshes with both idler gear 11 of first countershaft w_v1 and with idler gear 17 of second countershaft w_v2. In the sixth gear plane 12-6, as a single gear plane, fixed gear 6 of first transmission input shaft w_k1 meshes with idler gear 12 of first countershaft w_v1.

In the first and second variant embodiments according to FIGS. 1 to 4, in each case, two singly operative coupling devices A and C are provided on the first countershaft w_v1, which are arranged so that the activated coupling device A firmly connects idler gear 7, and the activated coupling device C firmly connects idler gear 9, in each case to first countershaft w_v1. Furthermore, two doubly operative coupling devices H-I and J-K and two singly operative coupling devices G and L are provided on the second countershaft w_v2, which are arranged so that the activated coupling device G firmly connects idler gear 13, the activated coupling device H firmly connects idler gear 14, the activated coupling device I firmly connects idler gear 15, the activated coupling device J firmly connects idler gear 16, the activated coupling device K firmly connects idler gear 17, and the activated coupling device L firmly connects idler gear 18, in each case, to second countershaft w_v2.

In the third, fourth and eighth, 1 l ^{th} and 15^{th} variant embodiments according to FIGS. 5, 7, 15, 21 and 29, in each case one doubly operative coupling device B-C or D-E and two singly operative coupling devices A and D or C and F are provided on the first countershaft w_v1, which are arranged so that the activated coupling device A firmly connects idler gear 7, the activated coupling device B firmly connects idler gear 8, the activated coupling device C firmly connects idler gear 9, the activated coupling device D firmly connects idler gear 10, the activated coupling device E firmly connects idler gear 11, and the activated coupling device F firmly connects idler gear 12, in each case to the first countershaft w_v1. On second countershaft w_v2, one doubly operative coupling device H-I or J-K and two singly operative coupling devices I and L, or G and J, or G and H, or G and K are provided, which are arranged so that the activated coupling device G firmly connects idler gear 13, the activated coupling device H firmly connects idler gear 14, the activated coupling device I firmly connects idler gear 15, the activated coupling device J firmly connects idler gear 16, the activated coupling device K firmly connects idler gear 17, and the activated coupling device L firmly connects idler gear 18, in each case to the second countershaft w_v2.

In the fifth and ninth variant embodiments according to FIGS. 9 and 17, two doubly operative coupling device B-C and D-E as well as two singly operative coupling devices A and F are provided on the first countershaft, which are arranged so that the activated coupling device A firmly connects idler gear 7, the activated coupling device B firmly connects idler gear 8, the activated coupling device C firmly connects idler gear 9, the activated coupling device D firmly connects idler gear 10, the activated coupling device E firmly connects idler gear 11, and the activated coupling device F firmly connects idler gear 12, in each case to the first countershaft w_v1. On the second countershaft w_v2, one doubly operative coupling device H-I or J-K is provided, which is arranged so that the activated coupling device H firmly connects idler gear 14, the activated coupling device I firmly connects idler gear 15, the activated coupling device J firmly connects idler gear 16, and the activated coupling device K firmly connects idler gear 17, in each case to the second countershaft w_v2. In the 13^{th} variant embodiment according to FIG. 25, the only difference is that instead of the doubly operative coupling devices, two singly operative coupling devices I and K are provided on the second countershaft w_v2, which are arranged so that the activated coupling device I firmly connects idler gear 15 and the activated coupling device K firmly connects idler gear 17, in each case to the second countershaft w_v2.

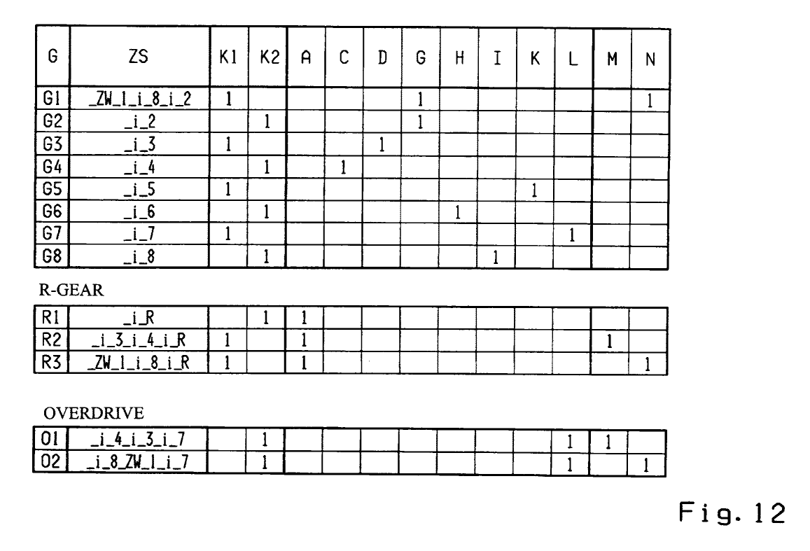

In the sixth variant embodiment according to FIGS. 11 and 12, three singly operative coupling devices A, C and D are provided on the first countershaft w_v1, which are arranged so that the activated coupling device A firmly connects idler gear 7, the activated coupling device C firmly connects idler gear 9, and the activated coupling device D firmly connects idler gear 10, in each case to the first countershaft w_v1. On the second countershaft, one doubly operative coupling device H-I and three singly operative coupling devices G, K and L are provided, which are arranged so that the activated coupling device G firmly connects idler gear 13, the activated coupling device H firmly connects idler gear 14, the activated coupling device I firmly connects idler gear 15, the activated coupling device K firmly connects idler gear 17, and the activated coupling device L firmly connects idler gear 18, in each case to the second countershaft w_v2.

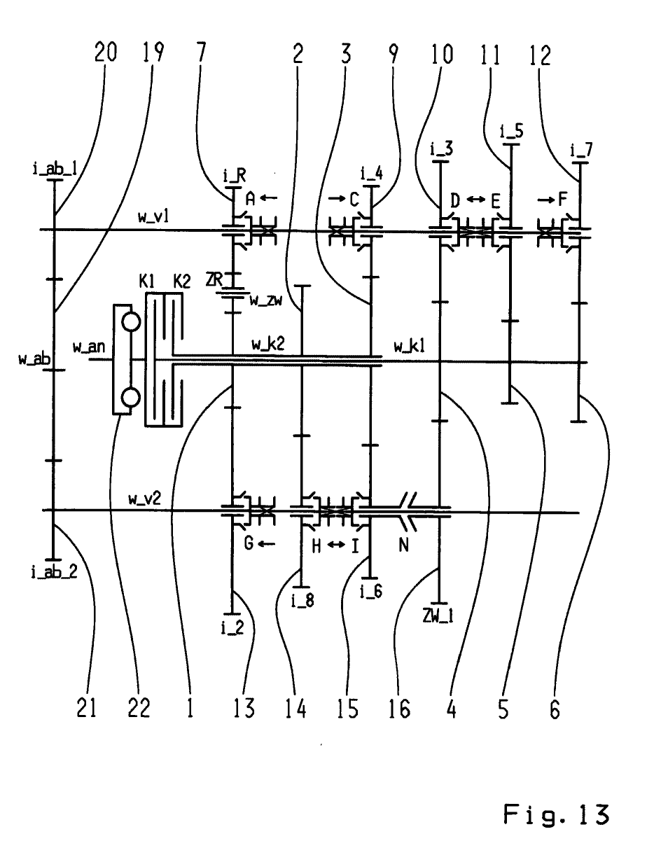

In the seventh and 10th variant embodiments according to FIGS. 13 and 19, one doubly operative coupling device D-E and three singly operative coupling devices A, C and F are provided on the first countershaft w_v1, which are arranged so that the activated coupling device A firmly connects idler gear 7, the activated coupling device C firmly connects idler gear 9, the activated coupling device D firmly connects idler gear 10, the activated coupling device E firmly connects idler gear 11, and the activated coupling device F firmly connects idler gear 12, in each case to the first countershaft w_v1. On the second countershaft w_v2, one doubly operative coupling device H-I or J-K as well as one singly operative coupling device G or H is provided, which are arranged so that the activated coupling device G firmly connects idler gear 13, the activated coupling device H firmly connects idler gear 14, the activated coupling device I firmly connects idler gear 15, the activated coupling device J firmly connects idler gear 16, and the activated coupling device K firmly connects idler gear 17, in each case to the second countershaft w_v2.

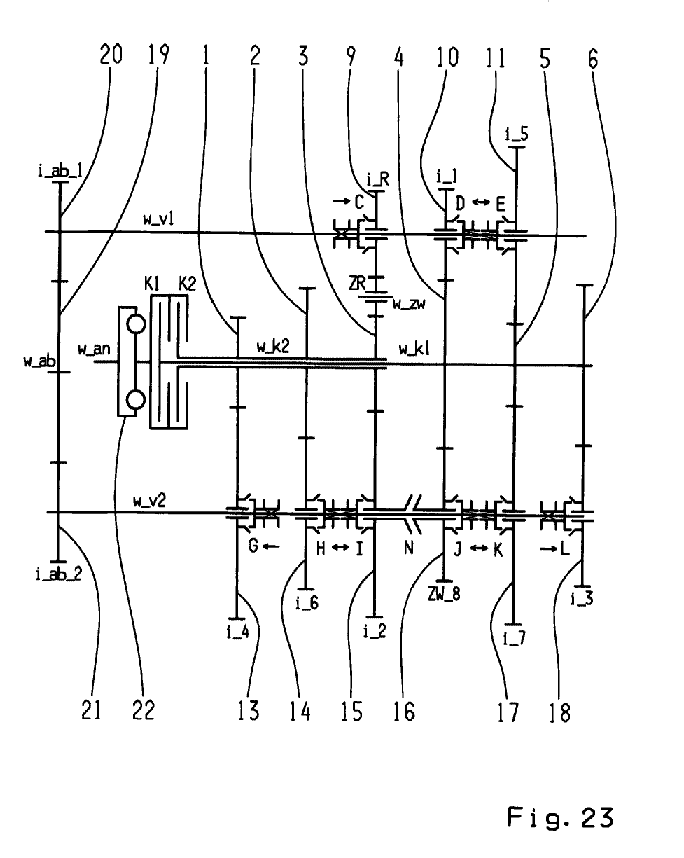

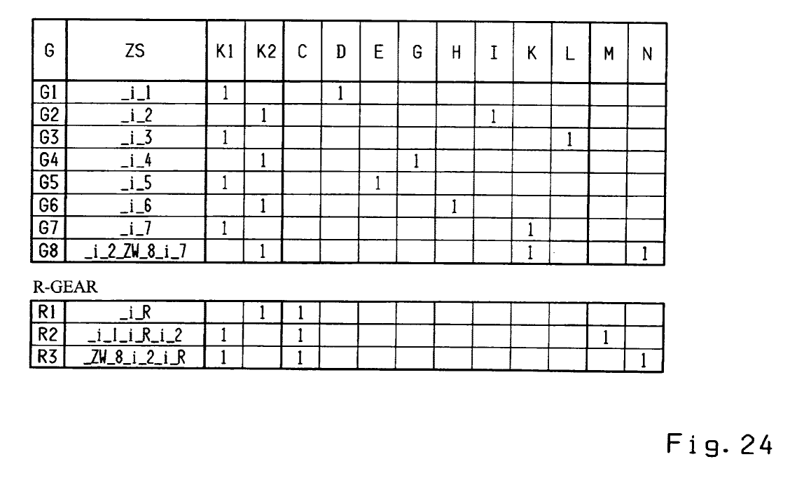

In the 12^{th} variant embodiment according to FIGS. 23 and 24, one doubly operative coupling device D-E and one singly operative coupling device C are provided on the first countershaft w_v1, which are arranged so that the activated coupling device C firmly connects idler gear 9, the activated coupling device D firmly connects idler gear 10, and the activated coupling device E firmly connects idler gear 11, in each case to the first countershaft w_v1. On the second countershaft w_v2, two doubly operative coupling devices H-I and J-K and two singly operative coupling devices G and L are provided, which are arranged so that the activated coupling device G firmly connects idler gear 13, the activated coupling device H firmly connects idler gear 14, the activated coupling device I firmly connects idler gear 15, the activated coupling device J firmly connects idler gear 16, the activated coupling device K firmly connects idler gear 17, and the activated coupling device L firmly connects idler gear 18, in each case to the second countershaft w_v2.

In the 14^{th} variant embodiment according to FIGS. 27 and 28, one doubly operative coupling device D-E and one singly operative coupling device F are provided on the first countershaft w_v1, which are arranged so that the activated coupling device D firmly connects idler gear 10, the activated coupling device E firmly connects idler gear 11, and the activated coupling device F firmly connects idler gear 12, in each case to the first countershaft w_v1. On the second countershaft w_v2, one doubly operative coupling device H-I and three singly operative coupling devices G, K and L are provided, which are arranged so that the activated coupling device G firmly connects idler gear 13, the activated coupling device H firmly connects idler gear 14, the activated coupling device I firmly connects idler gear 15, the activated coupling device K firmly connects idler gear 17, and the activated coupling device L firmly connects idler gear 18, in each case to the second countershaft w_v2.

Independent of the respective variant embodiment, an integrated output stage with the output gear 20 and with the output gear 21 is provided in the double clutch transmission according to the invention. The output gear 20 and the output gear 21 each mesh with a fixed gear 19 of output shaft w_ab. Optimally, shiftable connections are realized between output gears 20, 21, on the one hand, and the assigned countershafts w_v1, w_v2, on the other hand, by shiftable coupling devices S_ab1, S_ab2, which are not depicted in the illustrations.

Furthermore, it turns out in the case of the double clutch transmission according to the invention that at least the forward gears G1 to G8 can be designed so that they are power shiftable. In addition, depending on the variant embodiment, at least one reverse gear and/or crawler gears and/or overdrive gears, for example, can also be designed as winding path gears to be power shiftable. The details of each variant embodiment will be evident from the shift patterns described below.

The table depicted in FIG. 2 shows an example of a shift pattern for the first variant embodiment of the eight-speed double clutch transmission according to FIG. 1.

It is evident from the shift pattern that the first forward gear G1 is shiftable by means of the first clutch K1, the activated coupling device G, and the activated shift element N as winding path gear, that the second forward gear G2 is shiftable by means of the second clutch K2 and the activated coupling device G, that the third forward gear G3 is shiftable by means of the first clutch K1 and the activated coupling device K, that the fourth forward gear G4 is shiftable by means of the second clutch K2 and the activated coupling device C, that the fifth forward gear G5 is shiftable by means of the first clutch K1 and the activated coupling device J, that the sixth forward gear G6 is shiftable by means of the second clutch K2 and the activated coupling device H, that the seventh forward gear G7 is shiftable by means of the first clutch K1 and the activated coupling device L, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the second clutch K2 and the activated coupling device A. A reverse gear R2 can be shifted by means of the first clutch K1, the activated coupling device A and also as a winding path gear when shift element N is activated.

Finally, an overdrive gear O1 can be shifted by means of the second clutch K2 and the activated coupling device L, and also as a winding path gear when shift element N is activated.

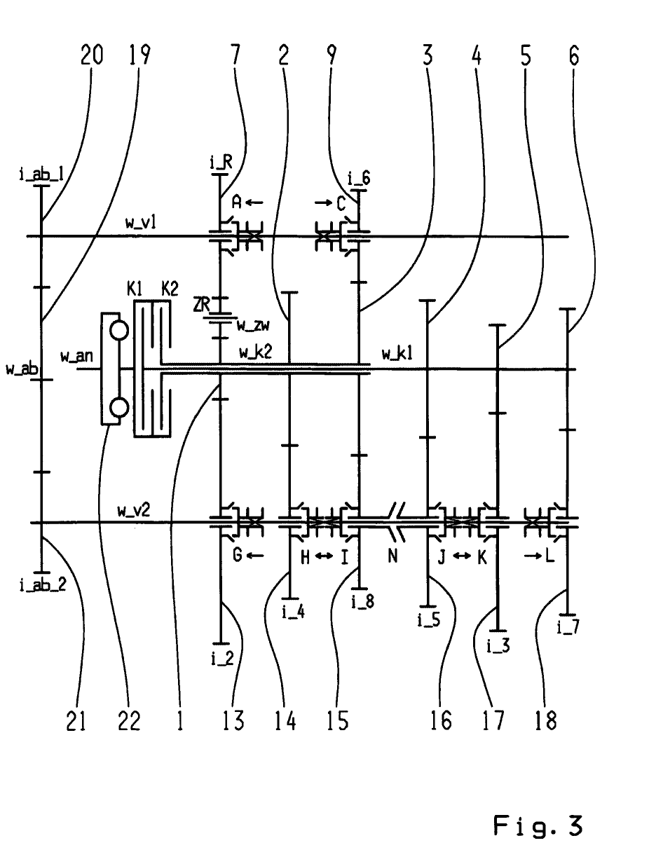

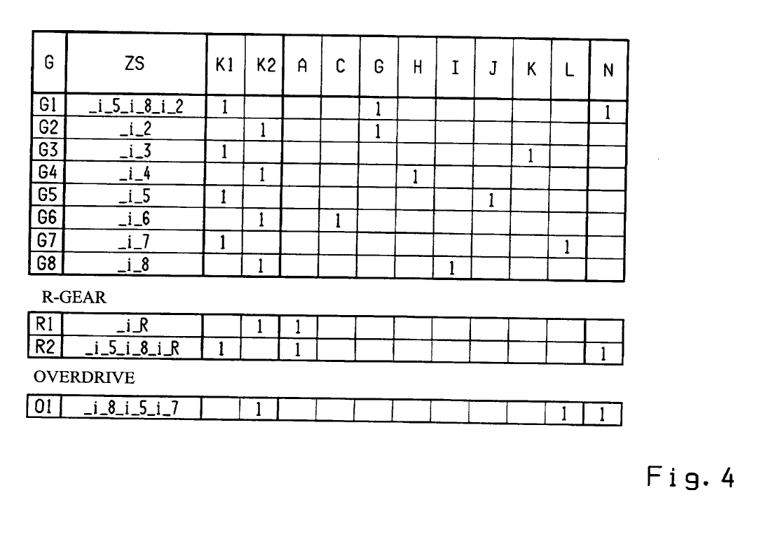

The table depicted in FIG. 4 shows the example of a shift pattern for the second variant embodiment of the eight-speed double clutch transmission according to FIG. 3.

It is evident from the shift patterns that the first forward gear G1 is shiftable by means of the first clutch K1, the activated coupling device G, and also as winding path gear when the shift element N is activated, that the second forward gear G2 is shiftable by means of the second clutch K2 and the activated coupling device G, that the third forward gear G3 is shiftable by means of the first clutch K1 and the activated coupling device K, that the fourth forward gear G4 is shiftable by means of the second clutch K2 and the activated coupling device H, that the fifth forward gear G5 is shiftable by means of the first clutch K1 and the activated coupling device J, that the sixth forward gear G6 is shiftable by means of the second clutch K2 and the activated coupling device C, that the seventh forward gear G7 is shiftable by means of the first clutch K1 and the activated coupling device L, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the second clutch K2 and the activated coupling device A. A reverse gear R2 can be shifted by means of the first clutch K1, the activated coupling device A and as a winding path gear when the shift element N is activated.

Finally, an overdrive gear O1 is shiftable by means of the second clutch K2 and the activated coupling device L, and also as a winding path gear when the shift element N is activated.

The table depicted in FIG. 6 shows the example of a shift pattern for the third variant embodiment of the eight-speed double clutch transmission according to FIG. 5.

It is evident from the shift pattern that the first forward gear G1 is shiftable by means of the first clutch K1 and the activated coupling device A, and also as a winding path gear when the shift element N is activated, that the second forward gear G2 is shiftable by means of the second clutch K2 and the activated coupling device A, that the third forward gear G3 is shiftable by means of the first clutch K1 and the activated coupling device K, that the fourth forward gear G4 is shiftable by means of the second clutch K2 and the activated coupling device B, that the fifth forward gear G5 is shiftable by means of the first clutch K1 and the activated coupling device J, that the sixth forward gear G6 is shiftable by means of the second clutch K2 and the activated coupling device C, that the seventh forward gear G7 is shiftable by means of the first clutch K1 and the activated coupling device L, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the first clutch K1 and the activated coupling device D. A reverse gear R2 can be shifted by means of the first clutch K1 and the activated coupling device A and also as a winding path gear when the shift element M is activated. A reverse gear R3 can be shifted by means of the first clutch K1 and the activated coupling device B and also as a winding path gear when the shift element M is activated. A reverse gear R4 can be shifted by means of the first clutch K1 and the activated coupling device C and also as a winding path gear when the shift element M is activated.

Finally, an overdrive gear O1 is shiftable by means of the second clutch K2 and the activated coupling device L and also as a winding path gear when the shift element N is activated.

The table depicted in FIG. 8 shows the example of a shift pattern for the fourth variant embodiment of the eight-speed double clutch transmission according to FIG. 7.

It is evident from the shift pattern that the first forward gear G1 is shiftable by means of the first clutch K1 and the activated coupling device G and also as a winding path gear when the shift element N is activated, that the second forward gear G2 is shiftable by means of the second clutch K2 and the activated coupling device G, that the third forward gear G3 is shiftable by means of the first clutch K1 and the activated coupling device E, that the fourth forward gear G4 is shiftable by means of the second clutch K2 and the activated coupling device C, that the fifth forward gear G5 is shiftable by means of the first clutch K1 and the activated coupling device J, that the sixth forward gear G6 is shiftable by means of the second clutch K2 and the activated coupling device H, that the seventh forward gear G7 is shiftable by means of the first clutch K1 and the activated coupling device F, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the first clutch K1 and the activated coupling device D. A reverse gear R2 can be shifted by means of the first clutch K1 and the activated coupling device G and also as a winding path gear when the shift element M is activated. A reverse gear R3 can be shifted by means of the first clutch K1 and the activated coupling device H and also as a winding path gear when the shift element M is activated. A reverse gear R4 can be shifted by means of the second clutch K2 and the activated coupling device D and also as a winding path gear when the shift element N is activated.

Finally, an overdrive gear O1 is shiftable by means of the second clutch K2 and the activated coupling device F and also as a winding path gear when the shift element N is activated.

The table depicted in FIG. 10 shows the example of a shift pattern for the fifth variant embodiment of the eight-speed double clutch transmission according to FIG. 9.

It is evident from the shift pattern that the first forward gear G1 is shiftable by means of the first clutch K1 and the activated coupling device H and also as a winding path gear when the shift element N is activated, that the second forward gear G2 is shiftable by means of the second clutch K2 and the activated coupling device H, that the third forward gear G3 is shiftable by means of the first clutch K1 and the activated coupling device D, that the fourth forward gear G4 is shiftable by means of the second clutch K2 and the activated coupling device C, that the fifth forward gear G5 is shiftable by means of the first clutch K1 and the activated coupling device E, that the sixth forward gear G6 is shiftable by means of the second clutch K2 and the activated coupling device A, that the seventh forward gear G7 is shiftable by means of the first clutch K1 and the activated coupling device F, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the second clutch K2 and the activated coupling device B. A reverse gear R2 can be shifted by means of the first clutch K1 and the activated coupling device B and also as a winding path gear when the shift element M is activated. Furthermore, a reverse gear R3 can be shifted by means of the first clutch K1 and the activated coupling device B and also as a winding path gear when the shift element N is activated.

Finally, an overdrive gear O1 is shiftable by means of the second clutch K2 and the activated coupling device F and also as a winding path gear when the shift element M is activated. An overdrive gear 02 can be shifted by means of the second clutch K2 and the activated coupling device F and also as a winding path gear when the shift element N is activated.

The table depicted in FIG. 12 shows the example of a shift pattern for the sixth variant embodiment of the eight-speed double clutch transmission according to FIG. 11.

It is evident from the shift pattern that the first forward gear G1 is shiftable by means of the first clutch K1 and the activated coupling device G and also as a winding path gear when the shift element N is activated, that the second forward gear G2 is shiftable by means of the second clutch K2 and the activated coupling device G, that the third forward gear G3 is shiftable by means of the first clutch K1 and the activated coupling device D, that the fourth forward gear G4 is shiftable by means of the second clutch K2 and the activated coupling device C, that the fifth forward gear G5 is shiftable by means of the first clutch K1 and the activated coupling device K, that the sixth forward gear G6 is shiftable by means of the second clutch K2 and the activated coupling device H, that the seventh forward gear G7 is shiftable by means of the first clutch K1 and the activated coupling device L, and that the eighth forward gear G8 is shiftable by means of the second clutch K2 and the activated coupling device I. Thus, at least the first eight forward gears can be designed to be power shiftable.

Moreover, a reverse gear R1, for example, can be shifted by means of the second clutch K2 and the activated coupling device A. A reverse gear R2 can be shifted by means of the first clutch K1 and the activated coupling device A and also as a winding path gear when the shift element M is activated. Furthermore, a reverse gear R3 can be shifted by means of the first clutch K1 and the activated coupling device A and also as a winding path gear when the shift element N is activated.

Finally, an overdrive gear O1 is shiftable by means of the second clutch K2 and the activated coupling device L and also as a winding path gear when the shift element M is activated. An overdrive gear O2 can be shifted by means of the second clutch K2 and the activated coupling device L and also as a winding path gear when the shift element N is activated.

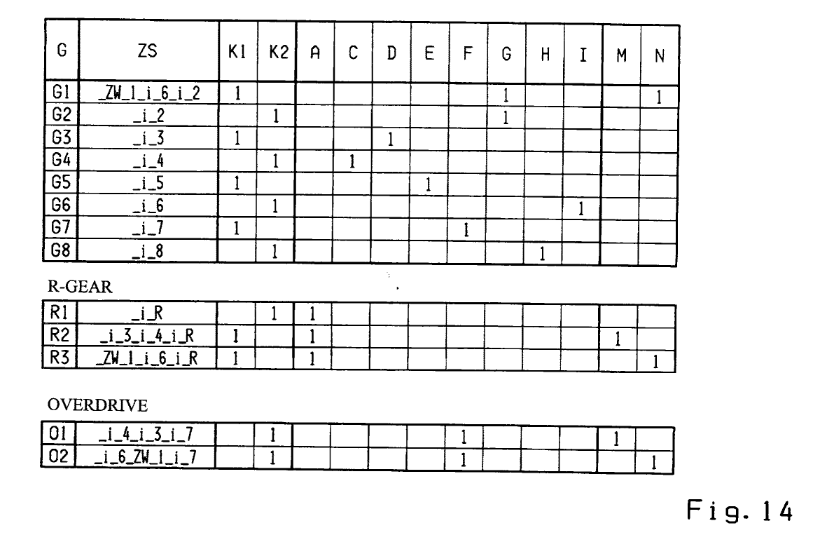

The table depicted in FIG. 14 shows the example of a shift pattern for the seventh variant embodiment of the eight-speed double clutch transmission according to FIG. 13.

It is evident from the shift pattern that the first forward gear G1 is shiftable by means of the first clutch K1 and the activated coupling device G and also as a winding path gear when the shift element N is activated, that the second forward gear G2 is shiftable by means of the second clutch K2 and the activated coupling device G, that the third forward gear G3 is shiftable by means of the first clutch K1 and the activated coupling device D, that the fourth forward gear G4 is shiftable by means of the second clutch K2 and the activated coupling device C, that the fifth forward gear G5 is shiftable by means of the first clutch K1 and the activated coupling device E, that the sixth forward gear G6 is shiftable by means of the second clutch K2 and the activated coupling device I, that the seventh forward gear G7 is shiftable by means of the first clutch K1 and the activated coupling device F, and that the eighth forward gear G8 is shiftable by means of the second clutch K2 and the activated coupling device H. Thus, at least the first eight forward gears can be designed to be power shiftable.

Moreover, a reverse gear R1, for example, can be shifted by means of the second clutch K2 and the activated coupling device A. A reverse gear R2 can be shifted by means of the first clutch K1 and the activated coupling device A and also as a winding path gear when the shift element M is activated. Furthermore, a reverse gear R3 can be shifted by means of the first clutch K1 and the activated coupling device A and also as a winding path gear when the shift element N is activated.

An overdrive gear O1 can be shifted by means of the second clutch K2 and the activated coupling device F and also as a winding path gear when the shift element M is activated. An overdrive gear O2 can be shifted by means of the second clutch K2 and the activated coupling device F and also as a winding path gear when the shift element N is activated.

The table depicted in FIG. 16 shows the example of a shift pattern for the eighth variant embodiment of the eight-speed double clutch transmission according to FIG. 15.

It is evident from the shift pattern that the first forward gear G1 is shiftable by means of the first clutch K1 and the activated coupling device F, that the second forward gear G2 is shiftable by means of the second clutch K2 and the activated coupling device C, that the third forward gear G3 is shiftable by means of the first clutch K1 and the activated coupling device J, that the fourth forward gear G4 is shiftable by means of the second clutch K2 and the activated coupling device G, that the fifth forward gear G5 is shiftable by means of the first clutch K1 and the activated coupling device E, that the sixth forward gear G6 is shiftable by means of the second clutch K2 and the activated coupling device H, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the first clutch K1 and the activated coupling device D. A reverse gear R2 can be shifted by means of the second clutch K2 and the activated coupling device F and also as a winding path gear when the shift element M is activated. Furthermore, a reverse gear R3 can be shifted by means of the first clutch K1 and the activated coupling device I and also as a winding path gear when the shift element M is activated. A reverse gear R4 can be shifted by means of the second clutch K2 and the activated coupling device D and also as a winding path gear when the shift element N is activated.

The table depicted in FIG. 18 shows the example of a shift pattern for the ninth variant embodiment of the eight-speed double clutch transmission according to FIG. 17.

It is evident from the shift pattern that the first forward gear G1 is shiftable by means of the first clutch K1 and the activated coupling device F, that the second forward gear G2 is shiftable by means of the second clutch K2 and the activated coupling device C, that the third forward gear G3 is shiftable by means of the first clutch K1 and the activated coupling device J, that the fourth forward gear G4 is shiftable by means of the second clutch K2 and the activated coupling device A, that the fifth forward gear G5 is shiftable by means of the first clutch K1 and the activated coupling device E, that the sixth forward gear G6 is shiftable by means of the second clutch K2 and the activated coupling device B, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the first clutch K1 and the activated coupling device D. A reverse gear R2 can be shifted by means of the second clutch K2 and the activated coupling device D and as a winding path gear when the shift element M is activated. Furthermore, a reverse gear R3 can be shifted by means of the second clutch K2 and the activated coupling device D and as a winding path gear when the shift element N is activated. Advantageously, the reverse gear R2 is designed in a power shiftable fashion in particular relative to the first forward gear G1.

The table depicted in FIG. 20 shows the example of a shift pattern for the 10^{th} variant embodiment of the eight-speed double clutch transmission according to FIG. 19.

It is evident from the shift pattern that the first forward gear G1 is shiftable by means of the first clutch K1 and the activated coupling device F, that the second forward gear G2 is shiftable by means of the second clutch K2 and the activated coupling device C, that the third forward gear G3 is shiftable by means of the first clutch K1 and the activated coupling device J, that the fourth forward gear G4 is shiftable by means of the second clutch K2 and the activated coupling device A, that the fifth forward gear G5 is shiftable by means of the first clutch K1 and the activated coupling device E, that the sixth forward gear G6 is shiftable by means of the second clutch K2 and the activated coupling device H, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the first clutch K1 and the activated coupling device D. A reverse gear R2 can be shifted by means of the second clutch K2 and the activated coupling device F and also as a winding path gear when the shift element M is activated. Furthermore, a reverse gear R3 can be shifted by means of the second clutch K2 and the activated coupling device D and also as a winding path gear when the shift element N is activated. In the foremost fashion, the reverse gear R2 is designed in a power shiftable fashion in particular relative to the first forward gear G1.

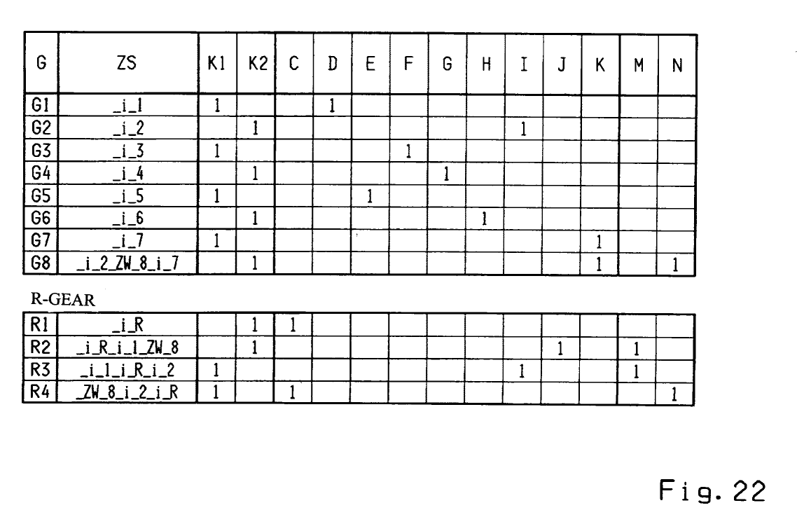

The table depicted in FIG. 22 shows the example of a shift pattern for the 11^{th} variant embodiment of the eight-speed double clutch transmission according to FIG. 21.

It is evident from the shift pattern that the first forward gear G1 is shiftable by means of the first clutch K1 and the activated coupling device D, that the second forward gear G2 is shiftable by means of the second clutch K2 and the activated coupling device I, that the third forward gear G3 is shiftable by means of the first clutch K1 and the activated coupling device F, that the fourth forward gear G4 is shiftable by means of the second clutch K2 and the activated coupling device G, that the fifth forward gear G5 is shiftable by means of the first clutch K1 and the activated coupling device E, that the sixth forward gear G6 is shiftable by means of the second clutch K2 and the activated coupling device H, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the second clutch K2 and the activated coupling device C. A reverse gear R2 can be shifted by means of the second clutch K2 and the activated coupling device J and also as a winding path gear when the shift element M is activated. Furthermore, a reverse gear R3 can be shifted by means of the first clutch K1 and the activated coupling device I and also as a winding path gear when the shift element M is activated. A reverse gear R4 can be shifted by means of the first clutch K1 and the activated coupling device C and also as a winding path gear when the shift element N is activated.

The table depicted in FIG. 24 shows the example of a shift pattern for the 12^{th} variant embodiment of the eight-speed double clutch transmission according to FIG. 23.

It is evident from the shift pattern that the first forward gear G1 is shiftable by means of the first clutch K1 and the activated coupling device D, that the second forward gear G2 is shiftable by means of the second clutch K2 and the activated coupling device I, that the third forward gear G3 is shiftable by means of the first clutch K1 and the activated coupling device L, that the fourth forward gear G4 is shiftable by means of the second clutch K2 and the activated coupling device G, that the fifth forward gear G5 is shiftable by means of the first clutch K1 and the activated coupling device E, that the sixth forward gear G6 is shiftable by means of the second clutch K2 and the activated coupling device H, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the second clutch K2 and the activated coupling device C. A reverse gear R2 can be shifted by means of the first clutch K1 and the activated coupling device C and also as a winding path gear when the shift element M is activated. Furthermore, a reverse gear R3 can be shifted by means of the first clutch K1 and the activated coupling device C and also as a winding path gear when the shift element N is activated.

The table depicted in FIG. 26 shows the example of a shift pattern for the 13^{th} variant embodiment of the eight-speed double clutch transmission according to FIG. 25.

It is evident from the shift pattern that the first forward gear G1 is shiftable by means of the first clutch K1 and the activated coupling device D, that the second forward gear G2 is shiftable by means of the second clutch K2 and the activated coupling device I, that the third forward gear G3 is shiftable by means of the first clutch K1 of the activated coupling device F, that the fourth forward gear G4 is shiftable by means of the second clutch K2 and the activated coupling device A, that the fifth forward gear G5 is shiftable by means of the first clutch K1 and the activated coupling device E, that the sixth forward gear G6 is shiftable by means of the second clutch K2 and the activated coupling device B, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the second clutch K2 and the activated coupling device C. A reverse gear R2 can be shifted by means of the second clutch K2 and the activated coupling device J and also as a winding path gear when the shift element M is activated. Furthermore, a reverse gear R3 can be shifted by means of the first clutch K1 and the activated coupling device I and also as a winding path gear when the shift element M is activated. A reverse gear R4 can be shifted by means of the first clutch K1 and the activated coupling device C and also as a winding path gear when the shift element N is activated.

The table depicted in FIG. 28 shows the example of a shift pattern for the 14^{th} variant embodiment of the eight-speed double clutch transmission according to FIG. 27.

It is evident from the shift pattern that the first forward gear G1 is shiftable by means of the first clutch K1 and the activated coupling device L, that the second forward gear G2 is shiftable by means of the second clutch K2 and the activated coupling device G, that the third forward gear G3 is shiftable by means of the first clutch K1 and the activated coupling device D, that the fourth forward gear G4 is shiftable by means of the second clutch K2 and the activated coupling device I, that the fifth forward gear G5 is shiftable by means of the first clutch K1 and the activated coupling device E, that the sixth forward gear G6 is shiftable by means of the second clutch K2 and the activated coupling device H, that the seventh forward gear G7 is shiftable by means of the first clutch K1 and the activated coupling device K, and that the eighth forward gear G8 is shiftable by means of the second clutch K2 and the activated coupling device K and also as a winding path gear when the shift element N is activated. Thus, at least the first eight forward gears can be designed to be power shiftable.

Moreover, a reverse gear R1, for example, can be shifted by means of the first clutch K1 and the activated coupling device F. A reverse gear R2 can be shifted by means of the second clutch K2 and the activated coupling device F and also as a winding path gear when the shift element N is activated.

The table depicted in FIG. 30 shows the example of a shift pattern for the 15^{th} variant embodiment of the eight-speed double clutch transmission according to FIG. 29.

It is evident from the shift pattern that the first forward gear G1 is shiftable by means of the first clutch K1 and the activated coupling device J, that the second forward gear G2 is shiftable by means of the second clutch K2 and the activated coupling device C, that the third forward gear G3 is shiftable by means of the first clutch K1 and the activated coupling device F, that the fourth forward gear G4 is shiftable by means of the second clutch K2 and the activated coupling device G, that the fifth forward gear G5 is shiftable by means of the first clutch K1 and the activated coupling device K, that the sixth forward gear G6 is shiftable by means of the second clutch K2 and the activated coupling device H, that the seventh forward gear G7 is shiftable by means of the first clutch K1 and the activated coupling device E, and that the eighth forward gear G8 is shiftable by means of the second clutch K2 and the activated coupling device E and also as a winding path gear when the shift element N is activated. Thus, at least the first eight forward gears can be designed to be power shiftable.

Moreover, a reverse gear R1, for example, can be shifted by means of the first clutch K1 and the activated coupling device D. A reverse gear R2 can be shifted by means of the second clutch K2 and the activated coupling device J and also as a winding path gear when the shift element M is activated. Furthermore, a reverse gear R3 can be shifted by means of the first clutch K1 and the activated coupling device I and also when the shift element M is activated. A reverse gear R4 can be shifted by means of the second clutch K2 and the activated coupling device D and also as a winding path gear when the shift element N is activated. In an advantageous manner, the reverse gear R2 is designed in a power shiftable fashion in particular relative to the first forward gear G1.

The shift patterns according to the first, second, third and fourth variant embodiments according to the FIGS. 2 to 8 show, in detail, that in the first forward gear G1, starting from the first clutch K1 the gear stages i_5, i_8 and i_2 are used, the two subtransmissions being coupled by means of the activated shift element N. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eight forward gear G8 uses gear stage i_8.

In addition, it is evident from the shift patterns of the first and second variant embodiments that the reverse gear R1, starting from the second clutch K2, uses the gear stage i_R. Furthermore, the additional reverse gear R2, starting from the first clutch K1, uses the gear stages i_5, i_8 and i_R, with the shift element N being activated to couple the two subtransmissions.

The overdrive gear O1, starting from the second clutch K2, uses the gear stages i_8, i_5 and i_7, with the two subtransmissions being coupled when the shift element N is activated.

It is furthermore evident from the third variant embodiment according to FIG.

6 that the reverse gear R1, starting from the first clutch K1, uses the gear stage i_R. Furthermore, the additional reverse gear R2, starting from the first clutch K1, uses the gear stages i_R, i_6 and i_2, with the shift element M being activated to couple the two subtransmissions. The reverse gear R3, starting from the first clutch K1, uses the gear stages i_R, i_6 and i_4, with the two subtransmissions being coupled by means of the shift element M. The reverse gear R4, starting from the first clutch K1, uses the gear stages i_R, i_6 and i_8, with two subtransmissions being coupled by means of the activated shift element M.

The overdrive gear O1, starting from the second clutch K2, uses the gear stages i_8, i_5 and i_7, with the two subtransmissions being coupled when the shift element N is activated.

In the fourth variant embodiment according to FIG. 8, it is furthermore evident that the reverse gear R1, starting from the first clutch K1, uses the gear stage i_R. Furthermore, the additional reverse gear R2, starting from the first clutch K1, uses the gear stages i_R, i_4 and i_2, with the shift element M being activated to couple the two subtransmissions. The reverse gear R3, starting from the first clutch K1, uses the gear stages i_R, i_4 and i_6, with the two subtransmissions being coupled by means of the activated shift element M. The reverse gear R4, starting from the first clutch K1, uses the gear stages i_8, i_5 and i_R, with two subtransmissions being coupled by means of the activated shift element N.

The overdrive gear O1, starting from the second clutch K2, uses the gear stages i_8, i_5 and i_7, with the two subtransmissions being coupled when the shift element N is activated.

From the shift patterns of the fifth and the sixth variant embodiments according to FIGS. 10 to 12 it is evident, in detail, that the first forward gear G1, starting from the first clutch K1, uses the gear stages ZW_1, i_8 and i_2, with the two subtransmissions being coupled by means of the activated shift element N. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eighth forward gear G8 uses gear stage i_8.

The reverse gear R1, starting from the second clutch K2, uses the gear stage i_R. The reverse gear R2, starting from the first clutch K1, uses the gear stages i_3, i_4 and i_R, with the shift element M being activated to couple the two subtransmissions. The reverse gear R3, starting from the first clutch K1, uses gear stages ZW_1, i_8 and i_R, with the two subtransmissions being coupled by means of the activated shift element N.

Overdrive gear O1, starting from the second clutch K2, uses the gear stages i_4, i_3 and i_7, with the two subtransmissions being coupled when the shift element M is activated. Overdrive gear O2, starting from the second clutch K2, uses the gear stages i_8, ZW_1 and i_7, with the two subtransmissions being coupled when the shift element N is activated.

It is evident from the shift pattern of the seventh variant embodiment, according to FIGS. 13 and 14, that the first forward gear G1, starting from the first clutch K1, uses the gear stages ZW_1, i_6 and i_2, with the two subtransmissions being coupled by means of the activated shift element N. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eighth forward gear G8 uses gear stage i_8.

The reverse gear R1, starting from the second clutch K2, uses the gear stage i_R. Furthermore, the additional reverse gear R2, starting from the first clutch K1, uses the gear stages i_3, i_4 and i_R, with the shift element M being activated to couple the two subtransmissions. The reverse gear R3, starting from the first clutch K1, uses the gear stages ZW_1, i_6 and i_R, with the two subtransmissions being coupled by means of the activated shift element N.

The overdrive gear O1, starting from the second clutch K2, uses the gear stages i_4, i_3 and i_7, with the two subtransmissions being coupled when the shift element M is activated. The overdrive gear O2, starting from the second clutch K2, uses the gear stages i_6, ZW_1 and i_7, with the two subtransmissions being coupled when the shift element N is activated.

It is evident from the shift patterns in the eight, ninth and tenth variant embodiments, according to FIGS. 15 to 20, that the first forward gear G1, starting from the first clutch K1, uses gear stage i_1, the second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eighth forward gear G8, starting from the second clutch K2, uses gear stages ZW_8, i_3 and i_7, with the two subtransmissions being coupled by means of the activated shift element N.

In the eight variant embodiment according to FIG. 16, the reverse gear R1, starting from the first clutch K1, uses the gear stage i_R. Furthermore, the additional reverse gear R2, starting from the second clutch K2, uses the gear stages i_2, i_R and i_6, with the shift element M being activated to couple the two subtransmissions. The reverse gear R3, starting from the first clutch K1, uses the gear stages i_R, i_2 and ZW_8, with the two subtransmissions being coupled by means of the activated shift element M. The reverse gear R4, starting from the second clutch K2, uses the gear stages ZW_8, i_3 and i_R, with the two subtransmissions being coupled by means of the activated shift element N.

In the ninth variant embodiment according to FIG. 18, the reverse gear R1, starting from the first clutch K1, uses the gear stage i_R. Furthermore, the additional reverse gear R2, starting from the second clutch K2, uses the gear stages i_2, i_R, i_1, with the shift element M being activated to couple the two subtransmissions. The reverse gear R3, starting from the first clutch K1, uses the gear stages ZW_8, i_3 and i_R, with the two subtransmissions being coupled by means of the activated shift element N.

In the tenth variant embodiment according to FIG. 20, the reverse gear R1, starting from the first clutch K1, uses the gear stage i_R. Furthermore, the additional reverse gear R2, starting from the second clutch K2, uses the gear stages i_2, i_R, i_1, with the shift element M being activated to couple the two subtransmissions.

The reverse gear R3, starting from the first clutch K1, uses the gear stages ZW_8, i_3 and i_R, with the two subtransmissions being coupled by means of the activated shift element N.

It is evident from the shift patterns of the 11^{th,} 12^{th} and 13^{th} variant embodiments, according to FIGS. 21 to 26, that the first forward gear G1, starting from the first clutch K1, uses the gear stage i_1, the second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eighth forward gear G8, starting from the second clutch K2, uses gear stages i_2, ZW_8 and i_7, with the two subtransmissions being coupled by means of the activated shift element N.

In the eleventh variant embodiment according to FIG. 22, the reverse gear R1, starting from the second clutch K2, uses the gear stage i_R. Furthermore, the additional reverse gear R2, starting from the second clutch K2, uses the gear stages i_R, i_1, and ZW_8, with the shift element M being activated to couple the two subtransmissions. The reverse gear R3, starting from the first clutch K1, uses the gear stages i_1, i_R and i_2, with the two subtransmissions being coupled by means of the activated shift element M. The reverse gear R4, starting from the first clutch K1, uses the gear stages ZW_8, i_2 and i_R, with the two subtransmissions being coupled by means of the activated shift element N.

In the twelfth variant embodiment according to FIG. 24, the reverse gear R1, starting from the second clutch K2, uses the gear stage i_R. Furthermore, the additional reverse gear R2, starting from the first clutch K1, uses the gear stages i_1, i_R, i_2, with the shift element M being activated to couple the two subtransmissions. The reverse gear R3, starting from the first clutch K1, uses the gear stages ZW_8, i_2 and i_R, with the two subtransmissions being coupled by means of the activated shift element N.

In the 13^{th} variant embodiment according to FIG. 26, the reverse gear R1, starting from the second clutch K2, uses the gear stage i_R. Furthermore, the additional reverse gear R2, starting from the second clutch K2, uses the gear stages i_R, i_1 and ZW_8, with the shift element M being activated to couple the two subtransmissions. The reverse gear R3, starting from the first clutch K1, uses the gear stages i_1, i_R and i_2, with the two subtransmissions being coupled by means of the activated shift element M. The fourth reverse gear R4, starting from the first clutch K1, uses the gear stages ZW_8, i_2 and i_R, with the two subtransmissions being coupled by means of the activated shift element N.

It is evident from the shift pattern of the 14^{th} variant embodiment, according to the FIGS. 27 and 28, that the first forward gear G1, starting from the first clutch K1, uses the gear stage i_1, the second forward gear G2 uses gear stage i_2, the third forward gear G3 uses gear stage i_3, the fourth forward gear G4 uses gear stage 1_4, the fifth forward gear G5 uses gear stage i_5, the sixth forward gear G6 uses gear stage i_6, the seventh forward gear G7 uses gear stage i_7, and the eighth forward gear G8, starting from the second clutch K2, uses gear stages i_4, ZW_8 and i_7, with the two subtransmissions being coupled by means of the activated shift element N.

In the 14^{th} variant embodiment according to FIG. 28, the reverse gear R1, starting from the first clutch K1, uses the gear stage i_R. Furthermore, the additional reverse gear R2, starting from the second clutch K2, uses the gear stages i_4, ZW_8 and i_R, with the shift element N being activated to couple the two subtransmissions.

It is evident from the shift pattern of the 15^{th} variant embodiment, according to FIGS. 29 and 30, that the first forward gear C1, starting from the first clutch K1, uses the gear stage i_1, the second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6, the seventh forward gear G7 uses gear stage i_7, and the eighth forward gear G8, starting from the second clutch K2, uses gear stages ZW_8, i_1, and i_7, with the two subtransmissions being coupled by means of the activated shift element N.

In the 15^{th} variant embodiment according to FIG. 30, the reverse gear R1, starting from the first clutch K1, uses the gear stage i_R. Furthermore, the additional reverse gear R2, starting from the second clutch K2, uses the gear stages i_2, i_R and i_1, with the shift element M being activated to couple the two subtransmissions. The reverse gear R3, starting from the first clutch K1, uses the gear stages i_R, i_2 and ZW_8, with the shift element M being activated to couple the two subtransmissions. The reverse gear R4, starting from the second clutch K2, uses the gear stages ZW_8, i_1 and i_R, with the two subtransmissions being coupled by means of the activated shift element N.

In summary, it is evident from the first, second, third and fourth variant embodiment, according to FIGS. 1 to 8, that the first forward gear is realized as a winding path gear by means of the gear stages of the fifth, eighth and second gear. Furthermore, two dual gear planes and four single gear planes are provided. Moreover, to save fuel, an overdrive gear can be power-shifted relative to the seventh forward gear.

It is furthermore evident from the first variant embodiment that there are two reverse gears that are power-shifted relative to each other. Arranging the gear stages of the fifth, sixth and seventh gear on single gear planes results in a good gradation adaptation, in particular for the higher gears.

In detailed terms, it is evident from the first variant embodiment that in the first gear plane 7-13, as a dual gear plane, idler gear 7 is used for two reverse gears R1, R2 and idler gear 13 is used for two forward gears G1, G2. In the second gear plane 2-14, as a single gear plane, idler gear 14 is used for one forward gear G6. In the third gear plane 9-15, as a dual gear plane, idler gear 9 is used for one forward gear G4 and idler gear 15 is used for three forward gears G1, G8, O1 and for one reverse gear R2. In the fourth gear plane 4-16, as a single gear plane, idler gear 16 is used for three forward gears G1, G5, O1 and for one reverse gear R2. In the fifth gear plane 5-17, as a single gear plane, idler gear 17 is used for one forward gear G3. Finally, in the sixth gear plane 6-18, as a single gear plane, idler gear 18 is used for two forward gears G7, O1.

The second variant embodiment also realizes two reverse gears that are power-shiftable relative to each other. Because the gear stages of the sixth and eighth gear are in a dual gear plane results in similar axial distances between the countershafts and the drive shaft. Thus, similar proportions are realized, which facilitates construction.

In detailed terms, it is evident from the second variant embodiment that in the first gear plane 7-13, as a dual gear plane, idler gear 7 is used for two reverse gears R1, R2 and idler gear 13 is used for two forward gears G1, G2. In the second gear plane 2-14, as a single gear plane, idler gear 14 is used for one forward gear G4. In the third gear plane 9-15, as a dual gear plane, idler gear 9 is used for one forward gear G6 and idler gear 15 is used for three forward gears G1, G8, O1 as well as for one reverse gear R2. In the fourth gear plane 4-16, as a single gear plane, idler gear 16 is used for three forward gears G1, G5, O1 and for one reverse gear R2. In the fifth gear plane 5-17, as a single gear plane, idler gear 17 is used for one forward gear G3. Finally, in the sixth gear plane 6-18, as a single gear plane, idler gear 18 is used for two forward gears G7, O1.

In the third variant embodiment, arranging the gear stages of the second, third and fourth gear on single gear planes results in a good gradation adaptation, in particular for the lower gears.

In detailed terms, it is evident from the third variant embodiment that in the first gear plane 1-13, as a single gear plane, idler gear 13 is used for two forward gears G1, G2 and for one reverse gear R2. In the second gear plane 2-14, as a single gear plane, idler gear 14 is used for one forward gear G6 and for one reverse gear R3. In the third gear plane 9-15, as a dual gear plane, idler gear 9 is used for one forward gear G4 and for two reverse gears R2, R3, and idler gear 15 is used for three forward gears G1, G8, O1 and for one reverse gear R4. In the fourth gear plane 10-16, as a dual gear plane, idler gear 10 is used for four reverse gears R1 to R4, and idler gear 16 is used for three forward gears G1, G5, O1 and for one reverse gear R4. In the fifth gear plane 11-5, as a single gear plane, idler gear 11 is used for one forward gear G3. Finally, in the sixth gear plane 12-6, as a single gear plane, idler gear 12 is used for two forward gears G7, O1.

The fourth variant embodiment also realizes two reverse gears that are power-shiftable relative to each other. Furthermore, this gear set realizes an optimal gradation adaptation.

In detailed terms, it is evident from the fourth variant embodiment that in the first gear plane 1-13, as a single gear plane, idler gear 13 is used for two forward gears G1, G2 and for one reverse gear R2. In the second gear plane 2-14, as a single gear plane, idler gear 14 is used for one forward gear G6 and for one reverse gear R3. In the third gear plane 9-15, as a dual gear plane, idler gear 9 is used for one forward gear G4 and for two reverse gears R2, R3, and idler gear 15 is used for three forward gears G1, G8, O1 and for one reverse gear R4. In the fourth gear plane 10-16, as a dual gear plane, idler gear 10 is used for four reverse gears R1 to R4, and idler gear 16 is used for three forward gears G1, G5, O1 and for one reverse gear R4. In the fifth gear plane 11-5, as a single gear plane, idler gear 11 is used for one forward gear G3. Finally, in the sixth gear plane 12-6, as a single gear plane, idler gear 12 is used for two forward gears G7, O1.

The fifth and sixth variant embodiments according to FIGS. 9 to 12, the first forward gear is realized as a winding path gear by means of the additional gear stage ZW_1, which is not used with any other forward gear, and by means of the gear stages of the eighth gear and the second gear. Furthermore, three dual gear planes and three single gear planes are provided. In addition, this results in two reverse gears that can be power-shifted relative to each other. Moreover, this results in one overdrive gear that can be power-shifted relative to the forward gear to save fuel.

In detailed terms, it is evident from the fifth variant embodiment that in the first gear plane 7-1, as a single gear plane, idler gear 7 is used for one forward gear G6. In the second gear plane 8-14, as a dual gear plane, idler gear 8 is used for three reverse gears R1 to R3, and idler gear 14 is used for two forward gears G1, G2. In the third gear plane 9-15, as a dual gear plane, idler gear 9 is used for two forward gears G4, O1 and for one reverse gear R2, and idler gear 15 is used for three forward gears G1, G8, O2 and for one reverse gear R3. In the fourth gear plane 10-16, as a dual gear plane, idler gear 10 is used for two forward gears G3, O1 and for one reverse gear R2, and idler gear 16 is used for two forward gears G1, O2 and for one reverse gear R3. In the fifth gear plane 11-5, as a single gear plane, idler gear 11 is used for one forward gear G5. Finally, in the sixth gear plane 12-6, idler gear 12 is used for three forward gears G7, O1, O2.

In the sixth variant embodiment according to FIGS. 11 and 12, a good gradation adaptation is realized.

In detailed terms, it is evident from the shift pattern according to FIG. 12 that in the first gear plane 7-13, as a dual gear plane, idler gear 7 is used for three reverse gears R1 to R3, and idler gear 13 is used for two forward gears G1, G2. In the second gear plane 2-14, as a single gear plane, idler gear 14 is used for one forward gear G6. In the third gear plane 9-15, as a dual gear plane, idler gear 9 is used for two forward gears G4, O1 and for one reverse gear R2, and idler gear 15 is used for three forward gears O1, G8, O2 and for one reverse gear R3. In the fourth gear plane 10-16, idler gear 10 is used for two forward gears G3, O1 and for one reverse gear R2, and idler gear 16 is used for two forward gears O1, O2 and for one reverse gear R3. In the fifth gear plane 5-17, as a single gear plane, idler gear 17 is used for one forward gear G5. Finally, in the sixth gear plane 6-18, as a single gear plane, idler gear 18 is used for three forward gears G7, O1, O2.

In the seventh variant embodiment according to FIGS. 13 to 14, the first forward gear is realized as a winding path gear by means of the additional gear stage ZW_1, which is not used with any other forward gear, as well as by means of the gear stages of the sixth gear and the second gear. Furthermore, there are two reverse gears that are power-shiftable relative to each other. Moreover, one overdrive gear that is power-shiftable relative to the seventh gear is realized to save fuel. Arranging the gear stages of the fifth, sixth and seventh gear on single gear planes results in a good gradation adaptation, in particular for the higher gears.

In detailed terms, it is evident from the shift pattern of the seventh variant embodiment that in the first gear plane 7-13, as a dual gear plane, idler gear 7 is used for three reverse gears R1 to R3, and idler gear 13 is used for two forward gears O1, G2. In the second gear plane 2-14, as a single gear plane, idler gear 14 is used for one forward gear G8. In the third gear plane 9-15, as a dual gear plane, idler gear 9 is used for two forward gears G4, O1 and for one reverse gear R2, and idler gear 15 is used for three forward gears G1, G6, O2 and for one reverse gear R3. In the fourth gear plane 10-16, as a dual gear plane, idler gear 10 is used for two forward gears G3, O1 and for one reverse gear R2, and idler gear 16 is used for two forward gears G1, O2 and for one reverse gear R3. In the fifth gear plane 11-5, as a single gear plane, idler gear 11 is used for one forward gear G5. Finally, in the sixth gear plane 12-6, as a single gear plane, idler gear 12 is used for three forward gears G7, O1, O2.

In summary, it is evident from the eighth, ninth, and tenth variant embodiment according to FIGS. 15 to 20 that an eighth forward gear is used as a winding path gear by means of the additional gear stage ZW_8, which is not used with any other forward gear, and by means of the gear stages of the third gear and the seventh gear. Furthermore, three dual gear planes and three single gear plans are provided. Moreover, two reverse gears that are power-shiftable relative to each other are feasible.

The eighth variant embodiment provides a compact structure of the countershafts.

In detailed terms, it is evident from the eighth variant embodiment that in the first gear plane 1-13, as a single gear plane, idler gear 13 is used for one forward gear G4. In the second gear plane 2-14, as a single gear plane, idler gear 14 is used one forward gear G6 and for one reverse gear R2. In the third gear plane 9-15, as a dual gear plane, idler gear 9 is used for one forward gear G2 and for two reverse gears R2, R3, and idler gear 15 is used for one forward gear G8 and for two reverse gears R2, R4. In the fourth gear plane 10-16, as a dual gear plane, idler gear 10 is used for four reverse gears R1 to R4, and idler gear 16 is used for two forward gears G3, G8 and for one reverse gear R4. In the fifth gear plane 11-17, as a dual gear plane, idler gear 11 is used for one forward gear G5, and idler gear 17 is used for two forward gears G7, G8. Finally, in the sixth gear plane 12-6, as a single gear plane, idler gear 12 is used for one forward gear G1.

In the ninth variant embodiment, the second countershaft is subjected to a lesser load because only three idler gears are arranged on the second countershaft immediately adjacent to each other, which is advantageous with respect to the design of the shaft and the bearings.

In detailed terms, it is evident from the ninth variant embodiment that in the first gear plane 7-1, as a single gear plane, idler gear 7 is used for one forward gear G4. In the second gear plane 8-2, as a single gear plane, idler gear 8 is used for one forward gear G6. In the third gear plane 9-15, as a dual gear plane, idler gear 9 is used for one forward gear G2 and for one reverse gear R2, and idler gear 15 is used for one forward gear G8 and for one reverse gear R3. In the fourth gear plane 10-16, as a dual gear plane, idler gear 10 is used for three reverse gears R1 to R3, and idler gear 16 is used for two forward gears G3, G8 and for one reverse gear R3. In the fifth gear plane 11-17 idler gear 11 is used for one forward gear G5, and idler gear 17 is used for two forward gears G7, G8. Finally, in the sixth gear plane 12-6, as a single gear plane, idler gear 12 is used for one forward gear G1 and for one reverse gear R2.

The gear set according to the 10^{th} variant embodiment is optimally adapted with respect to the gradation.

In detailed terms, it is evident from the 10^{th} variant embodiment that in the first gear plane 7-1, as a single gear plane, idler gear 7 is used for one forward gear G4. In the second gear plane 2-14, as a single gear plane, idler gear 14 is used for one forward gear G6. In the third gear plane 9-15, as a dual gear plane, idler gear 9 is used for one forward gear G2 and for one reverse gear R2, and idler gear 15 is used for one forward gear G8 and for one reverse gear R3. In the fourth gear plane 10-16, as a dual gear plane, idler gear 10 is used for three reverse gears R1 to R3, and idler gear 16 is used for two forward gears G3, G8 and for one reverse gear R3. In the fifth gear plane 11-17, as a dual gear plane, idler gear 11 is used for one forward gear G5, and idler gear 17 is used for two forward gears G7, G8. Finally, in the sixth gear plane 12-6, as a single gear plane, idler gear 12 is used for one forward gear G1 and for one reverse gear R2.

In the 11^{th}, 12^{th} and 13^{th} variant embodiment according to FIGS. 21 to 26, the eighth forward gear can be realized as a winding path gear by means of the gear stage of the second gear, by means of the additional gear stage ZW_8, which is not used with any other forward gear, and by means of the gear stage of the seventh gear. Furthermore, three single gear planes and three dual gear planes are provided. In addition, two reverse gears that are power-shiftable relative to each other can be realized.

The 11^{th} variant embodiment furthermore provides a compact structure of both countershafts due to the division of four idler gears relative to five idler gears.

In detailed terms, it is evident from the 11^{th} variant embodiment that in the first gear plane 1-13, as a single gear plane, idler gear 13 is used for one forward gear G4. In the second gear plane 2-14, as a single gear plane, idler gear 14 is used one forward gear G6. In the third gear plane 9-15, as a dual gear plane, idler gear 9 is used for four reverse gears R1 to R4, and idler gear 15 is used for two forward gears G2, G8 and for two reverse gears R3, R4. In the fourth gear plane 10-16, as a dual gear plane, idler gear 10 is used for one forward gear G1 and for two reverse gears R2, R3, and idler gear 16 is used for one forward gear G8 and for two reverse gears R2, R4. In the fifth gear plane 11-17, as a dual gear plane, idler gear 11 is used for one forward gear G5, and idler gear 17 is used for two forward gears G7, G8. Finally, in the sixth gear plane 12-6, as a single gear plane, idler gear 12 is used for one forward gear G3.

Because in the 12^{th} variant embodiment, only three idler gears are arranged on the first countershaft immediately adjacent to each other, the first countershaft is subjected to a lesser load, which is advantageous with respect to the design of the shaft and the bearings.

In detailed terms, it is evident from the 12^{th} variant embodiment that in the first gear plane 1-13, as a single gear plane, idler gear 13 is used for one forward gear G4. In the second gear plane 2-14, as a single gear plane, idler gear 14 is used for one forward gear G6. In the third gear plane 9-15, as a dual gear plane, idler gear 9 is used for three reverse gears R1 to R3, and idler gear 15 is used for two forward gears G2, G8 and for two reverse gears R2, R3. In the fourth gear plane 10-16, as a dual gear plane, idler gear 10 is used for one forward gear G1 and for one reverse gear R2, and idler gear 16 is used for one forward gear G8 and for one reverse gear R3. In the fifth gear plane 11-17, as a dual gear plane, idler gear 11 is used for one forward gear G5, and idler gear 17 is used for two forward gears G7, G8. Finally, in the sixth gear plane 6-18, as a single gear plane, idler gear 18 is used for one forward gear G3.

In the 13^{th} variant embodiment, the gear set has optimal adaptability with respect to gradation.

In detailed terms, it is evident from the 13^{th} variant embodiment that in the first gear plane 7-1, as a single gear plane, idler gear 7 is used for one forward gear G4. In the second gear plane 8-2, as a single gear plane, idler gear 8 is used for one forward gear G6. In the third gear plane 9-15, as a dual gear plane, idler gear 9 is used for four reverse gears R1 to R4, and idler gear 15 is used for two forward gears G2, G8 and for two reverse gears R3, R4. In the fourth gear plane 10-16, as a dual gear plane, idler gear 10 is used for one forward gear G1 and for two reverse gears R2, R3, and idler gear 16 is used for one forward gear G8 and for two reverse gears R2, R4. In the fifth gear plane 11-17, as a dual gear plane, idler gear 11 is used for one forward gear G5, and idler gear 17 is used for two forward gears G7, G8. Finally, in the sixth gear plane 12-6, as a single gear plane, idler gear 12 is used for one forward gear G3.

In the 14^{th} variant embodiment according to FIGS. 27 and 28, an eighth forward gear is realized as a winding path gear by means of the gear stage of the fourth gear, by means of the additional gear stage ZW_8, which is not used with any other forward gear, and by means of the gear stage of the seventh gear. Furthermore, three dual gear planes and three single gear planes are provided. Moreover, two reverse gears that are power-shiftable relative to each other are provided. Because only the gear stages of the second, fourth and sixth gear are shifted by means of the second clutch, the second clutch is subject to lesser loads and can be dimensioned in a smaller fashion.

In detailed terms, it is evident from the 14^{th} variant embodiment that in the first gear plane 1-13, idler gear 13 is used for one forward gear G2. In the second gear plane 2-14, as a single gear plane, idler gear 14 is used one forward gear G6. In the third gear plane 3-15, as a single gear plane, idler gear 15 is used for two forward gears G4, G8 and for one reverse gear R2. In the fourth gear plane 10-16, as a dual gear plane, idler gear 10 is used for one forward gear G3, and idler gear 16 is used for one forward gear G8 and for one reverse gear R2. In the fifth gear plane 11-17, as a dual gear plane, idler gear 11 is used for one forward gear G5, and idler gear 17 is used for two forward gears G7, G8. Finally, in the sixth gear plane 12-18, as a dual gear plane, idler gear 12 is used for two reverse gears R1, R2, and idler gear 18 is used for one forward gear G1.

In the 15^{th} variant embodiment according to FIGS. 29 and 30, the eighth forward gear is realized as a winding path gear by means of the additional gear stage ZW_8, which is not used with any other forward gear, and by means of the gear stages of the first and seventh gear. Furthermore, three dual gear planes and three single gear planes are provided. In addition, two reverse gears that are power-shiftable relative to each other are provided. Because of the division of four relative to five idler gears, the countershafts are constructed in a similarly compact fashion.

In detailed terms, it is evident from the 15^{th} variant embodiment that in the first gear plane 1-13, as a single gear plane, idler gear 13 is used for one forward gear G4. In the second gear plane 2-14, as a single gear plane, idler gear 14 is used for one forward gear G6. In the third gear plane 9-15, as a dual gear plane, idler gear 9 is used for one forward gear G2 and for two reverse gears R2, R3, and idler gear 15 is used for one forward gear G8 and for two reverse gears R3, R4. In the fourth gear plane 10-16, as a dual gear plane, idler gear 10 is used for four reverse gears R1 to R4, and idler gear 16 is used for two forward gears G1, G8 and for two reverse gears R2, R4. In the fifth gear plane 11-17, as a dual gear plane, idler gear 11 is used for two forward gears G7, G8, and idler gear 17 is used for one forward gear G5. Finally, in the sixth gear plane 12-6, as a single gear plane, idler gear 12 is used for one forward gear G3.

At least one additional gear stage ZW_x such as, for example, ZW_8 or ZW_1, can be inserted for winding path gears in one or even several variant embodiments; said additional gear stage is not used in a direct forward gear. Inserting an additional gear stage is evident from the respective figures of the variant embodiments.

It is also possible to use gear wheels x1, x2, . . . x7, x8 for additional winding path gears, which may be added to supplement a single gear plane, with the gear wheels x1, x2, . . . x7, x8 being numbered as follows. The numbering begins with the first gear wheel x1 of the first countershaft w_v1, starting from the assigned output stage i_ab_1 and continuing sequentially until the fourth gear wheel x4, with the first gear wheel on the second countershaft w_v2 starting from the assigned output stage i_ab_2 being designated as x5 and the additional gear wheels continuing sequentially to x8. If the additional gear wheel x1, x2, . . . x7, x8 is used in a reverse gear transmission, a rotation reversal will take place as, for example, through the use of an intermediate gear ZR on an intermediate shaft w_zw or the like.

In all variant embodiments of the double clutch transmission, because of these provisions for multiple use of individual idler gears, fewer gear planes are necessary, and thus fewer parts while the number of gears remains the same, so that an advantageous saving of construction space and cost is achieved.

Independent of the respective variant embodiment, the number “1” in a field of the respective table of the shift patterns according to FIGS. 2, 4, 6, 8, 10, 12, 14, 16, 18, 20, 22, 24, 26, 28 and 30 means that the assigned clutch K1, K2 and/or the assigned coupling device A, B, C, D, E, F, G, H, I, J, K, L and/or the assigned shift element M, N is respectively engaged and/or activated. On the other hand, a blank field in the respective table of shift patterns according to FIGS. 2, 4, 6, 8, 10, 12, 14, 16, 18, 20, 22, 24, 26, 28 and 30 means that the assigned clutch K1, K2 and/or the assigned coupling device A, B, C, D, E, F, G, H, I, J, K, L and/or the assigned shift element M, N is respectively disengaged.

Furthermore, in many cases, the possibility exists of inserting additional coupling- or shift elements without influencing the flow of force. This can enable gear preselection.

### REFERENCE SYMBOLS

1 Fixed gear of the second transmission input shaft
2 Fixed gear of the second transmission input shaft
3 Fixed gear of the second transmission input shaft
4 Fixed gear of the second transmission input shaft
5 Fixed gear of the second transmission input shaft
6 Fixed gear of the second transmission input shaft
7 Idler gear of the first countershaft
8 Idler gear of the first countershaft
9 Idler gear of the first countershaft
10 Idler gear of the first countershaft
11 Idler gear of the first countershaft
12 Idler gear of the first countershaft
13 Idler gear of the second countershaft
14 Idler gear of the second countershaft
15 Idler gear of the second countershaft
16 Idler gear of the second countershaft
17 Idler gear of the second countershaft
18 Idler gear of the second countershaft
19 Fixed gear of the output shaft
20 Output gear of the first counter shaft
21 Output gear of the second counter shaft
22 Torsion vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
A Coupling device
B Coupling device
C Coupling device
D Coupling device
E Coupling device
F Coupling device
G Coupling device
H Coupling device
I Coupling device
J Coupling device
K Coupling device
L Coupling device
i_1 Gear stage of first forward gear
i_2 Gear stage of second forward gear
i_3 Gear stage of third forward gear
i_4 Gear stage of fourth forward gear
i_5 Gear stage of fifth forward gear
i_6 Gear stage of sixth forward gear
i_7 Gear stage of seventh forward gear
i_8 Gear stage of eight forward gear
i_R Gear stage of reverse gear
ZW_1 Additional gear stage for winding path gears
ZW_8 Additional gear stage for winding path gears
i_ab_1 Output stage on the first counter shaft
i_ab_2 Output stage on the second counter shaft
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
O1 Overdrive
O2 Overdrive
R1 Reverse gear
R2 Reverse gear
3 Reverse gear
R4 Reverse gear
w_zw Intermediate shaft
ZR Intermediate gear for rotation reversal
ZS Utilized gear stage
M Optional shift element
N Shift element
S_ab1 Coupling device at the output stage, optional
S_ab2 Coupling device at the output stage, optional
Isb. Power shiftable

1-9. (canceled)

10. A double clutch transmission with first and second clutches (K1, K2) each having an input side connected to a drive shaft (w_an) and an output side respectively connected to one of first and second transmission input shafts (w k1, w_k2) arranged coaxially relative to one another, p1 at least first and second countershafts (w_v1, w_v2) on which toothed idler gearwheels (7, 8, 9, 10, 11, 12, 13, 14, 15, 16, 17, 18) being rotatably supported,
toothed fixed gearwheels (1, 2, 3, 4, 5, 6) being supported on the first and the second transmission input shafts (w_k1, w_k2) in a fixed manner, and each of the fixed gearwheels (1, 2, 3, 4, 5, 6) meshing with at least one of the idler gearwheels (7, 8, 9, 10, 11, 12, 13, 14, 15, 16, 17),
a plurality of coupling devices (A, B, C, D, E, F, G, H, I, J, K, L) for coupling an idler gearwheel (7, 8, 9, 10, 11, 12, 13, 14, 15, 16, 17, 18) with one of the first and the second countershafts (w_v1, w_v2) in a rotationally fixed manner,
an output gear (20, 21) being provided on each of the first and the second countershafts (w_v1, w_v2), each of the output gears (20, 21) being coupled with gearing of an output shaft (w_ab), and
at least one shift element (N) for the non-rotational connection of two toothed idler gearwheels (7, 8, 9, 10, 11, 12, 13, 14, 15, 16, 17, 18), with at least a plurality of power-shiftable forward gears (1, 2, 3, 4, 5, 6, 7, 8) and at least one shiftable reverse gear (R1, R2, R3, R4, R5),
wherein a maximum of six gear planes (7-1, 1-13, 7-13, 8-2, 2-14, 8-14, 3-15, 9-15, 4-16, 10-16, 11-5, 5-17, 11-17, 6-18, 12-6, 12-18) are provided of which at least two of the six gear planes are dual gear planes (7-13, 8-14, 9-15, 10-16, 11-17, 12-18) and, in each of the two dual gear planes (7-13, 8-14, 9-15, 10-16), one idler gearwheel (7, 8, 9, 10, 11, 12, 13, 14, 15, 16, 17, 18) of each of the first and the second countershafts (w v1, w_v2) is meshes with a fixed gearwheel (1, 2, 3, 4, 5, 6) of one of the first and the second transmission input shafts (w_k1, w_k2), and for each of the two dual gear planes (7-13, 8-14, 9-15, 10-16, 11-17, 12-18) at least one idler gear (7, 8, 9, 10, 11, 12, 13, 14, 15, 16, 17, 18) is usable for at least two gears, and at least three single gear planes (7-1, 1-13, 8-2, 2-14, 3-15, 4-16, 11-5, 5-17, 6-18, 12-6) are provided in which an idler gearwheel (7, 8, 11, 12, 13, 14, 18) of one of the first and the second countershafts (w_v1, w_v2) meshes with a fixed gearwheel (1, 2, 3, 4, 5, 6) of one of the first and the second transmission input shafts (w_K1, w_K2) so that at least one power shiftable winding path gear is shiftable by the at least one shift element (N).

11. The double clutch transmission according to claim 10, wherein the at least one shift element (N) is located on the second countershaft (w_v2) and activation of the at least one shift element (N), on the second countershaft (w_v2), an idler gear (15) of a second subtransmission is connectable with an idler gear (16) of a first subtransmission so that at least one of a first forward gear (G1) and an eighth forward gear (G8) is shiftable as winding path gears by the at least one shift element (N).

12. The double clutch transmission according to claim 11, wherein by an additional activatable shift element (M) is located on the first countershaft (w_v1), an idler gear (9) of the second subtransmission is connectable with an idler gear (10) of the first subtransmission so that at least one reverse gear (R2, R3, R4) is shiftable as a winding path gear by the additional activatable shift element (M) located on the first countershaft (w_v1).

13. The double clutch transmission according to claim 10, wherein first, second and third fixed gearwheels (1, 2, 3) of the second transmission input shaft (w_k2) of a second subtransmission are respectively assigned a first gear plane (7-13) as a dual gear plane, a second gear plane (2-14) as a single gear plane, and a third gear plane (9-15) as a dual gear plane, and first, second and third fixed gearwheels (4, 5, 6) of first transmission input shaft (w_k1) of a first subtransmission are respectively assigned a fourth gear plane (4-16) as a single gear plane, a fifth gear plane (5-17) as a single gear plane, and a sixth gear plane (6-18) as a single gear plane.

14. The double clutch transmission according to claim 10, wherein first, second and third fixed gearwheels (1, 2, 3) of the second transmission input shaft (w_k2) of a second subtransmission are respectively assigned a first gear plane (7-1, 1-13) as a single gear plane, a second gear plane (8-2, 2-14) as a single gear plane, and a third gear plane (9-15) as a dual gear plane, and that first, second and third fixed gearwheels (4, 5, 6) of first transmission input shaft (w_k1) of the second subtransmission are respectively assigned a fourth gear plane (10-16) as a dual gear plane, a fifth gear plane (11-5, 5-17) as a single gear plane, and a sixth gear plane (12-6, 6-18) as a single gear plane.

15. The double clutch transmission according to claim 10, wherein first, second and third fixed gearwheels (1, 2, 3) of second transmission input shaft (w_k2) of a second subtransmission are respectively assigned a first gear plane (7-1) as a single gear plane, a second gear plane (8-14) as a dual gear plane, and a third gear plane (9-15) as a dual gear plane, and first, second and third fixed gearwheels (4, 5, 6) of the first transmission input shaft (w_k1) of a first subtransmission are respectively assigned a fourth gear plane (10-16) as a dual gear plane, a fifth gear plane (11-5) as a single gear plane, and a sixth gear plane (12-6) as a single gear plane.

16. The double clutch transmission according to claim 10, wherein first, second and third fixed gearwheels (1, 2, 3) of second transmission input shaft (w_k2) of a second subtransmission are respectively assigned a first gear plane (7-13) as a dual gear plane, a second gear plane (2-14) as a single gear plane, and a third gear plane (9-15) as a dual gear plane, and first, second and third fixed gearwheels (4, 5, 6) of the first transmission input shaft (w_k1) of a first subtransmission are respectively assigned a fourth gear plane (10-16) as a dual gear plane, a fifth gear plane (5-17, 11-5) as a single gear plane, and a sixth gear plane (6-18, 12-6) as a single gear plane.

17. The double clutch transmission according to claim 10, wherein first, second and third fixed gearwheels (1, 2, 3) of the second transmission input shaft (w_k2) of a second subtransmission are respectively assigned a first gear plane (7-1, 1-13) as a single gear plane, a second gear plane (8-2, 2-14) as a single gear plane, and a third gear plane (9-15) as a dual gear plane, and first, second and third fixed gearwheels (4, 5, 6) of first transmission input shaft (w_k1) of the second subtransmission are respectively assigned a fourth gear plane (10-16) as a dual gear plane, a fifth gear plane (11-17) as a dual gear plane, and a sixth gear plane (12-6, 6-18) as a single gear plane.

18. The double clutch transmission according to claim 10, wherein first, second and third fixed gearwheels (1, 2, 3) of the second transmission input shaft (w_k2) of a second subtransmission are respectively assigned a first gear plane (1-13) as a single gear plane, a second gear plane (2-14) as a single gear plane, and a third gear (3-15) as a single gear plane, and first, second and third fixed gearwheels (4, 5, 6) of the first transmission input shaft (w_k1) of the second subtransmission are respectively assigned a fourth gear plane (10-16) as a dual gear plane, a fifth gear plane (11-17) as a dual gear plane, and a sixth gear plane (12-18) as a dual gear plane.
